(19) United States
(12) Patent Application Publication
(10) Pub. No.: US 2025/0278917 A1
(43) Pub. Date: Sep. 4, 2025

(54) IMAGE PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventor: Dazhi Luo, Shenzhen (CN)

(73) Assignee: TENCENT TECHNOLOGY (SHENZHEN) COMPANY LIMITED, Shenzhen (CN)

(21) Appl. No.: 19/210,117

(22) Filed: May 16, 2025

Related U.S. Application Data
(63) Continuation of application No. PCT/CN2024/087039, filed on Apr. 10, 2024.

(30) Foreign Application Priority Data
May 19, 2023 (CN) 202310572375.4

(51) Int. Cl. G06V 10/25; G06T 3/40; G06T 7/10; G06T 7/70

(52) U.S. Cl. CPC G06V 10/25; G06T 3/40; G06T 7/10; G06T 7/70; G06T 2207/20081; G06T 2207/20132; G06V 2201/07

(57) ABSTRACT

An image processing method includes, performing image detection on a portion of an image to obtain a first box set for marking an image detection result; deduplicating a first box in the first box set to obtain a second box set; performing position correction on a second box in the second box set to obtain a third box; generating, based on the third box, a third box set of adjusted boxes and a cropped image set including cropped images that are obtained by cropping the image based on the third box set; performing recognition and segmentation on the cropped images to obtain a segmentation result including segmented images, a number of the segmented images being less than or equal to a number of the adjusted boxes; and correcting the adjusted boxes, based on coordinate positions of the segmented images, to generate corrected boxes for the portion.

### CROSS-REFERENCE TO RELATED APPLICATIONS

This application is a continuation application of International Application No. PCT/CN2024/087039 filed on Apr. 10, 2024, which claims priority to Chinese Patent Application No. 202310572375.4 filed with the China National Intellectual Property Administration on May 19, 2023, the disclosures of each being incorporated by reference herein in their entireties.

### FIELD

The disclosure relates to the field of computer technologies, and to an image processing method and apparatus, a computer device, and a storage medium.

### BACKGROUND

Image detection is one of key issues in computer vision research, and is an important basis for understanding high-level semantic information of an image. For a portion (for example, a face of an object) of an image, difficulty in detection may be affected by diversity of portions, a change in an angle of view, an illumination condition, occlusion, and a complex background. This means that performing image detection on a portion of the image in a complex environment is a challenging task. In image detection methods on a portion of an image, a position of the portion of the image can be identified in a form of a bounding box. In the detection method, only an image detection task is considered, and insufficient importance is attached to a localization accuracy indicator of the bounding box. Localization of the bounding box is not sufficiently accurate. A detected bounding box may include some redundant information in addition to the portion, or not all information of the portion is detected. Accuracy of image detection is seriously affected.

### SUMMARY

According to an aspect of the disclosure, an image processing method includes, performing, based on an image being obtained, image detection on a first portion of the image to obtain a first box set including at least one box for marking an image detection result; deduplicating a first box in the first box set based on the image to obtain a second box set; performing position correction on a second box in the second box set to obtain a third box that is adjusted; generating, based on the third box, a third box set of adjusted boxes and a cropped image set corresponding to the third box set, the cropped image set including one or more first cropped images that are obtained by cropping the image based on one or more first adjusted boxes in the third box set; performing recognition and segmentation on the one or more first cropped images to obtain a segmentation result associated with the first portion, the segmentation result including one or more segmented images, a first number of the one or more segmented images being less than or equal to a second number of the one or more first adjusted boxes; and correcting the one or more first adjusted boxes, based on one or more coordinate positions of the one or more segmented images, to generate one or more corrected boxes for the first portion.

According to an aspect of the disclosure, an image processing apparatus includes, at least one memory configured to store computer program code; and at least one processor configured to read the program code and operate as instructed by the program code, the program code includes image detection code configured to cause at least one of the at least one processor to perform, based on an image being obtained, image detection on a first portion of the image to obtain a first box set including at least one box for marking an image detection result; deduplication and adjustment code configured to cause at least one of the at least one processor to deduplicate a first box in the first box set based on the image to obtain a second box set; perform position correction on a second box in the second box set to obtain a third box that is adjusted; and generate, based on the third box, a third box set of adjusted boxes and a cropped image set corresponding to the third box set, the cropped image set including one or more cropped images that are obtained by cropping the image based on one or more first adjusted boxes in the third box set; recognition and segmentation code configured to cause at least one of the at least one processor to perform recognition and segmentation on the one or more first cropped images to obtain a segmentation result associated with the first portion, the segmentation result including one or more segmented images, a first number of the one or more segmented images being less than or equal to a second number of the one or more first adjusted boxes; and correction code configured to cause at least one of the at least one processor to correct the one or more first adjusted boxes, based on one or more coordinate positions of the one or more segmented images, to generate one or more corrected boxes for the first portion.

According to an aspect of the disclosure, a non-transitory computer-readable storage medium, storing computer code which, when executed by at least one processor, causes the at least one processor to at least perform, based on an image being obtained, image detection on a first portion of the image to obtain a first box set including at least one box for marking an image detection result; deduplicate a first box in the first box set based on the image to obtain a second box set; perform position correction on a second box in the second box set to obtain a third box that is adjusted; generate, based on the third box, a third box set of adjusted boxes and a cropped image set corresponding to the third box set, the cropped image set including one or more cropped images that are obtained by cropping the image based on one or more first adjusted boxes in the third box set; perform recognition and segmentation on the one or more first cropped images to obtain a segmentation result associated with the first portion, the segmentation result including one or more segmented images, a first number of the one or more segmented images being less than or equal to a second number of the one or more first adjusted boxes; and correct the one or more first adjusted boxes, based on one or more coordinate positions of the one or more segmented images, to generate one or more corrected boxes for the first portion.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of a network architecture according to some embodiments.

FIG. 2 is a schematic diagram of a scenario in which image detection is performed on a portion of a to-be-detected image according to some embodiments.

FIG. 3 is a schematic flowchart of an image processing method according to some embodiments.

FIG. 4 is a schematic diagram of a scenario in which image detection is performed based on an image detection model according to some embodiments.

FIG. 5 is a schematic diagram of a scenario in which a candidate box set is deduplicated according to some embodiments.

FIG. 6 is a schematic diagram of a scenario in which position correction is performed based on an image offset adjustment model according to some embodiments.

FIG. 7 is a schematic diagram of a scenario in which recognition and segmentation are performed based on an image recognition and segmentation model according to some embodiments.

FIG. 8 is a schematic diagram of an image detection framework according to some embodiments.

FIG. 9 is a schematic flowchart of a training method for an image detection model according to some embodiments.

FIG. 10 is a schematic flowchart of a training method for an image offset adjustment model according to some embodiments.

FIG. 11 is a schematic flowchart of a training method for an image recognition and segmentation model according to some embodiments.

FIG. 12 is a schematic structural diagram of an image processing apparatus according to some embodiments.

FIG. 13 is a schematic diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide an iterative localization-type image detection method based on deep learning. The method is applied to the artificial intelligence (AI) field. AI involves a theory, a method, a technology, and an application system that use a digital computer or computing controlled by a digital computer to simulate, extend, and expand human intelligence, perceive an environment, obtain knowledge, and use the knowledge to obtain an optimal result. AI is a comprehensive technology in computer science and attempts to understand the essence of intelligence and produce a new intelligent machine that can react in a manner similar to human intelligence. AI is to study design principles and implementation methods of various intelligent machines, to enable the machines to have functions of perception, inference, and decision-making.

The AI technology is a comprehensive discipline, and relates to a wide range of fields including both hardware-level technologies and software-level technologies. Basic AI technologies may include technologies such as a sensor, a dedicated AI chip, cloud computing, distributed storage, a big data processing technology, an operating/interaction system, and electromechanical integration. AI software technologies include several major directions such as a computer vision (CV) technology, a speech processing technology, a natural language processing technology, machine learning/deep learning, autonomous driving, and intelligent traffic.

The CV technology is a science that studies how to use a machine to “see”, and that uses a camera and a computer to replace human eyes to perform machine vision such as recognition, detection, and measurement on a target, and further perform graphics processing, so that the computer processes the target into an image for human eyes to observe, or an image transmitted to an instrument for detection. As a scientific discipline, CV studies related theories and technologies and attempts to establish an AI system that can obtain information from images or multidimensional data. The CV technology may include image processing, image recognition, image semantic comprehension, image retrieval, optical character recognition (OCR), video processing, video semantic comprehension, content/behavior recognition, three-dimensional (3D) object reconstruction, a 3D technology, virtual reality, augmented reality, simultaneous localization and mapping, autonomous driving, and intelligent traffic.

ML is a multi-field interdiscipline, and relates to a plurality of disciplines such as the probability theory, statistics, the approximation theory, convex analysis, and the algorithm complexity theory, ML involves studying how a computer simulates or implements a human learning behavior to obtain new knowledge or skills, and reorganize an existing knowledge structure, to keep improving its performance. ML is the core of AI, is a basic way to make the computer intelligent, and is applied to various fields of AI. ML and deep learning may include technologies such as an artificial neural network, a belief network, reinforcement learning, transfer learning, inductive learning, and learning from demonstrations.

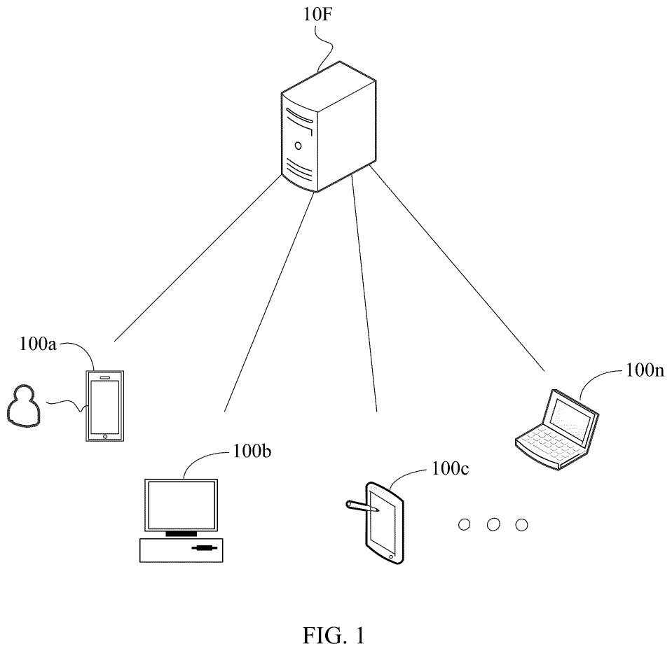

FIG. 1 is a schematic structural diagram of a network architecture according to some embodiments. As shown in FIG. 1, the network architecture may include a server 10F and a terminal device cluster. The terminal device cluster may include one or more terminal devices. A quantity of terminal devices is not limited herein. As shown in FIG. 1, the terminal device cluster may include a terminal device 100a, a terminal device 100b, a terminal device 100c, . . . , and a terminal device 100n. As shown in FIG. 1, the terminal device 100a, the terminal device 100b, the terminal device 100c, . . . , and the terminal device 100n each may establish a network connection to the server 10F, so that each terminal device can exchange data with the server 10F through the network connection. A connection mode of the network connection herein is not limited. A direct or indirect connection may be established through wired communication or wireless communication or in another manner. This is not limited.

Each terminal device in the terminal device cluster may include an intelligent terminal with an image processing function, such as a smartphone, a tablet computer, a notebook computer, a desktop computer, a smart speaker, a smartwatch, an in-vehicle terminal, or a smart television. A service application (for example, an application client) may be installed on each terminal device in the terminal device cluster shown in FIG. 1. When running on each terminal device, the application client may exchange data with the server 10F shown in FIG. 1. The application client may include a social client, a multimedia client (for example, a video client), an entertainment client (for example, a game client), an information stream client, an education client, a livestreaming client, and the like. The application client may be an independent client, or may be an embedded sub-client integrated in a client (for example, a social client, an education client, or a multimedia client). This is not limited herein.

As shown in FIG. 1, the server 10F in some embodiments may be a server corresponding to the application client. The server 10F may be an independent physical server, a server cluster or a distributed system including a plurality of physical servers, or a cloud server that provides a cloud computing service. A quantity of servers is not limited.

In some embodiments, one terminal device may be selected from the plurality of terminals devices shown in FIG. 1 as a service terminal device. For example, in some embodiments, the terminal device 100a shown in FIG. 1 may serve as a service terminal device, and a service application (for example, an application client) may be integrated in the service terminal device. The service terminal device may exchange data with the server 10F through a service data platform corresponding to the application client.

In some embodiments, the computer device with an image detection function may be a server, or may be any terminal device in the terminal device cluster shown in FIG. 1, for example, the terminal device 100a. A form of the computer device is not limited.

When obtaining a to-be-detected image, the computer device may perform image detection on a portion of the to-be-detected image to obtain a candidate box set, the candidate box set including a candidate box for marking an image detection result. The computer device deduplicates a candidate box in the candidate box set based on the to-be-detected image to obtain a to-be-processed box set, performs position correction on a candidate box in the to-be-processed box set to obtain an adjusted box, and generates, based on the adjusted box, an adjusted box set and a cropped image set corresponding to the adjusted box set. The cropped image set may include N cropped images, a cropped image is obtained by cropping the to-be-detected image based on an adjusted box in the adjusted box set, and N is a positive integer. Then the computer device may separately perform recognition and segmentation on each of the N cropped images to obtain a segmentation result associated with the portion, and may separately correct, based on coordinate positions of M segmented images in the segmentation result, adjusted boxes in the adjusted box set that correspond to the M segmented images, to accurately obtain M corrected boxes for indicating the portion of the to-be-detected image. Through deduplication, position correction, and a comprehensive consideration of an internal relationship between an image detection task and an image segmentation task, great importance is attached to a localization accuracy indicator of a bounding box in which the portion is located, to obtain the corrected box that can more precisely indicate the portion of the to-be-detected image, so that accuracy of image detection is effectively improved.

The image detection method provided in some embodiments may be widely applied to a plurality of application scenarios. The portion herein is a to-be-detected part of interest. When the portion is a body part of a service object (for example, a person or an animal), the image detection method may be applied to a video production scenario, a social and entertainment scenario, an identity recognition scenario, a security detection scenario, a human-computer interaction scenario, a medical and health scenario, and the like. When the portion is a non-compliant object (for example, some sensitive flags or sensitive symbols), the image detection method may be applied to a non-compliant object detection scenario. When the portion is an object of interest (for example, an advertising brand logo), the image detection method may be applied to an embedding detection scenario and the like.

For example, in the video production scenario, to derive extension functions such as cropping of a video clip collection for a character, calculation of an appearance rate of a character in a video, and display of character-associated information, the computer device may extract a key frame from a video as a to-be-detected image, and then may use the image detection method in some embodiments and an image detection and segmentation technology to not only accurately detect a corrected box in which a portion (for example, a human face) of the to-be-detected image is located, but also obtain a segmentation image (for example, a pixel-level foreground segmented image of the human face that is obtained by removing a background) corresponding to the corrected box. The computer device may use the corrected box and the segmented image corresponding to the corrected box as pre-data for subsequent character recognition, to implement the foregoing extension functions.

In the social and entertainment scenario, to provide richer social and entertainment experience for a user, the computer device may use an image obtained by the computer device in a service application such as a social application, a game application, or a photo processing application as a to-be-detected image, and then may use the image detection method in some embodiments and an image detection and segmentation technology to accurately detect a corrected box in which a portion (for example, a human face) of the to-be-detected image is located, and further implement functions such as selfie beautification, face changing, and face animation.

In the identity recognition scenario, when using an image captured in real time as a to-be-detected image, the computer device may use the image detection method in some embodiments and an image detection and segmentation technology to accurately detect a corrected box in which a portion (for example, a face) of the to-be-detected image is located, and then recognize information of the portion of the corrected box and compare the information with information in a database to implement automatic recognition and authentication. For example, in some service applications (for example, financial applications), facial recognition may be performed by using the image detection method, and subsequent services (for example, application login and asset transfer) are further performed when facial recognition and authentication succeed.

In the security detection scenario, cameras are arranged in public places, business districts, schools, residential districts, and the like. For example, when obtaining an image captured by a camera, the computer device may use the image as a to-be-detected image, and then may perform detection on a portion, for example, an animal face, of the to-be-detected image, perform further image recognition based on a detected corrected box, and compare recognized information with pet information of a lost pet to obtain a behavior path of the lost pet in a timely manner, so that the lost pet can be found more quickly.

In the human-computer interaction scenario, the computer device performs image detection on a human face in a to-be-detected image, and then may implement, based on a detected corrected box, human-computer interaction, for example, interaction functions such as a vending machine, a smart home appliance, and a smart door lock.

In the medical and health scenario, in the medical field, image detection (for example, facial detection) may be performed on a to-be-detected image of a patient, and remote management is implemented based on a detected corrected box through recognition and monitoring in a subsequent process. The image detection technology may be further applied to diagnosis and treatment, for example, diagnosing a facial skin condition of the patient based on a human face included in the corrected box.

The image detection method may be further applied to other scenarios, and examples are not described one by one herein. In some embodiments, a facial (or another biological feature) recognition technology is used. When some embodiments are applied to a product or technology, related data collection, use, and processing processes shall comply with requirements of national laws and regulations. Before facial information is collected, a target object shall be informed of information processing rules, and individual consent shall be obtained from the target object. The facial information is processed in strict compliance with requirements of laws and regulations and personal information processing rules, and technical measures are taken to ensure security of related data.

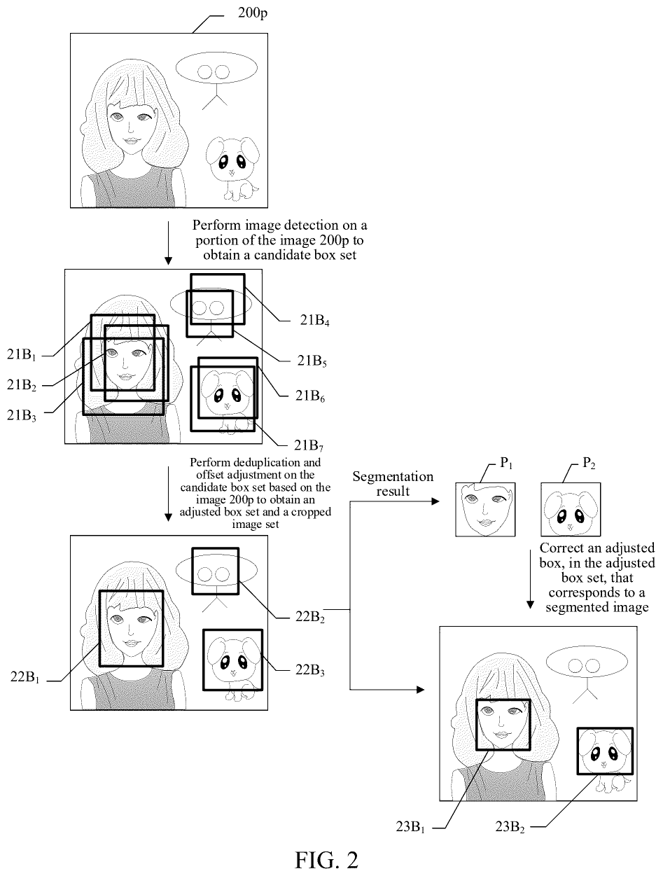

For ease of understanding, FIG. 2 is a schematic diagram of a scenario in which image detection is performed on a portion of a to-be-detected image according to some embodiments. As shown in FIG. 2, a computer device in some embodiments may be a computer device with an image detection function. The computer device may be any terminal device in the terminal device cluster shown in FIG. 1, for example, the terminal device 100a, or the computer device may be the server 10F shown in FIG. 1. The computer device is not limited herein.

As shown in FIG. 2, an image 200p may be a to-be-detected image obtained by the computer device. The image 200p may be an image of any key frame in video data, or may be a real-time image captured by the computer device through an image capture component (for example, an image shooting device or a camera), or may be an image (for example, an image in an album) stored on the computer device. Examples are not provided one by one herein.

When obtaining the image 200p, the computer device may include an image detection stage, an image deduplication and offset adjustment stage, and an image recognition and segmentation stage. In the image detection stage, the computer device may first perform image detection on a portion (for example, a face) in the image 200p to obtain a candidate box set. The candidate box set herein is a set including a plurality of bounding boxes that are configured for indicating the portion and that are obtained when the computer device performs image detection on the image 200p for the first time. For example, the candidate box set includes a candidate box for marking an image detection result. As shown in FIG. 2, for example, a quantity of candidate boxes in the candidate box set may be 7, and the candidate boxes may include a candidate box 21B₁, a candidate box 21B₂, a candidate box 21B₃, a candidate box 21B₄, a candidate box 21B₅, a candidate box 21B₆, and a candidate box 21B₇.

Because image detection is performed by using a sliding window, some regions of the portion are inevitably duplicate in the candidate box set obtained by the computer device. To effectively ensure a recall rate of image detection, the computer device may aggregate duplicate candidate boxes of the same portion into one candidate box, for example, may perform deduplication. In the image deduplication and offset adjustment stage, the computer device may deduplicate the candidate boxes in the candidate box set based on the image 200p to obtain a to-be-processed box set, perform position correction on a candidate box in the to-be-processed box set to obtain an adjusted box, and generate, based on the adjusted box, an adjusted box set and a cropped image set corresponding to the adjusted box set. The cropped image set may include N cropped images, N is a positive integer, and a cropped image is obtained by cropping the image 200p based on an adjusted box in the adjusted box set.

The deduplication and offset adjustment herein are an image processing method including deduplication and position correction, and a quantity of times of deduplication may be dynamically adjusted based on an actual case. This is not limited herein. For example, the deduplication and offset adjustment may include one round of deduplication and one round of position correction. After the candidate box set is deduplicated, position correction is performed, based on the image 200p, on each candidate box in a candidate box set obtained through deduplication. In some embodiments, the deduplication and offset adjustment may include two rounds of deduplication and one round of position correction. After the candidate box set is deduplicated, position correction is performed, based on the image 200p, on each candidate box in a candidate box set obtained through deduplication, and then an adjusted box obtained through position correction is deduplicated again.

As shown in FIG. 2, for example, a quantity of adjusted boxes in the adjusted box set obtained by the computer device may be 3, and the adjusted boxes may include an adjusted box 22B₁, an adjusted box 22B₂, and an adjusted box 22B₃. The cropped image set corresponding to the adjusted box set may include three cropped images, which may include a cropped image 1, a cropped image 2, and a cropped image 3. The cropped image 1 is a cropped image obtained by cropping the image 200p based on the adjusted box 22B₁. The cropped image 2 is a cropped image obtained by cropping the image 200p based on the adjusted box 22B₂. The cropped image 3 is a cropped image obtained by cropping the image 200p based on the adjusted box 22B₃.

In the image recognition and segmentation stage, the computer device may consider an internal relationship between an image detection task and an image segmentation task, and re-correct, by using a segmentation result obtained through recognition and segmentation, the candidate box set (for example, the adjusted box set) obtained through deduplication and offset adjustment. The segmentation result herein may include M segmented images, M being a positive integer less than or equal to N. The segmented image is an image (for example, a pixel-level foreground segmented image of the face that is obtained by removing a background) obtained by segmenting a recognized cropped image that belongs to the portion.

As shown in FIG. 2, the computer device may separately perform recognition and segmentation on each of the three cropped images to obtain a segmentation result associated with the portion. The segmentation result may include a segmented image P₁ and a segmented image P₂. The computer device may separately correct adjusted boxes in the adjusted box set that correspond to the two segmented images. For example, the computer device may correct the adjusted box 22B₁ in the adjusted box set based on a coordinate position of the segmented image P₁ to obtain a corrected box 23B₁. The computer device further may correct the adjusted box 22B₃ in the adjusted box set based on a coordinate position of the segmented image P₂ to obtain a corrected box 23B₂. This means that, after correcting the adjusted box set based on the segmented images in the segmentation result, the computer device in some embodiments can obtain two bounding boxes (for example, corrected boxes) for indicating the portion of the image 200p, for example, faces of two different service objects exist in the image 200p.

In some embodiments, during image detection on the portion of the image 200p, the image detection stage, the image deduplication and offset adjustment stage, the image recognition and segmentation stage, and the like are connected in series to complete an end-to-end closed-loop design of image detection and image segmentation, so that great importance is attached to a localization accuracy indicator of the bounding box in which the portion is located. According to some embodiments, quick detection can be performed on a complex portion (for example, a human face) in a to-be-detected image, and high precision, a high recall rate, and very high localization accuracy of a bounding box are achieved. A multi-function characteristic is further achieved. A corrected box may be output, or a pixel-level background-removed segmented image may be output.

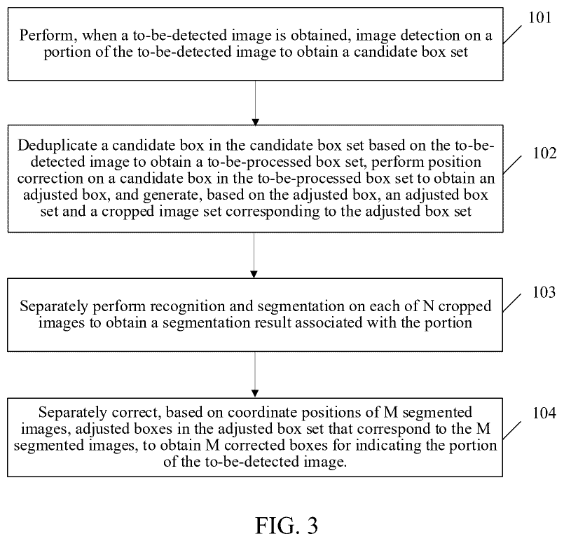

For some embodiments in which a computer device with an image detection function performs deduplication and offset adjustment and considering an internal connection between an image detection task and an image segmentation task when performing image detection on a portion of a to-be-detected image to obtain a corrected box for indicating the portion of the to-be-detected image, refer to the following descriptions corresponding to FIG. 3 to FIG. 11.

FIG. 3 is a schematic flowchart of an image processing method according to some embodiments. As shown in FIG. 3, the method may be performed by a computer device with an image detection function. The computer device may be a terminal device (for example, any terminal device in the terminal device cluster shown in FIG. 1, for example, the terminal device 100a), or may be a server (for example, the server 10F shown in FIG. 1). This is not limited herein. For ease of understanding, some embodiments are described by using an example in which the method is performed by the server. The method may include at least the following operation 101 to operation 104.

Operation 101: Perform, when a to-be-detected image is obtained, image detection on a portion of the to-be-detected image to obtain a candidate box set.

The candidate box set herein is obtained by the computer device by invoking an image detection model to perform image detection on the portion of the to-be-detected image. The candidate box set includes a candidate box for marking an image detection result (the image detection result may be a possible region found through image detection, and the candidate box is configured for marking the possible region). For example, the candidate box set may include K candidate boxes, K being a positive integer. The image detection model is further configured to determine a predicted category confidence respectively corresponding to each candidate box in the candidate box set. The predicted category confidence herein is a probability that a category corresponding to the candidate box is a portion category. A higher predicted category confidence indicates a higher possibility that the candidate box includes the portion. A model input of the image detection model is the to-be-detected image. A model output of the image detection model indicates whether the portion exists in the to-be-detected image. If the portion exists in the to-be-detected image, a coordinate position of a candidate box in which the portion is located is output, in a format of [x, y, w, h], x and y being coordinates of a vertex (for example, coordinates of an upper-left corner) of the candidate box, w being a width corresponding to the candidate box, and h being a height corresponding to the candidate box.

The image detection model may further automatically crop the to-be-detected image based on the coordinate position of the candidate box, to output a cropped image including the portion. The image detection model in some embodiments performs detection on the to-be-detected image with very high coverage, to determine whether a suspected portion exists in the to-be-detected image. If a suspected portion exists in the to-be-detected image, a bounding box (for example, a candidate box) in which the portion is located is obtained through cropping and is stored in a picture format (for example, a JPG format), to obtain an image file.

The image detection model is the first stage in the image detection process in some embodiments, and an operation speed of the image detection model largely determines an operation speed of an overall process. Expressiveness of the image detection model is also sufficiently strong for completing a coarse detection task. Based on the foregoing two factors, the image detection model in some embodiments may include two network structures. One is a first network structure in which a model input supports a fixed image size, and the other is a second network structure in which a model input supports any image size. Compared with the first network structure, the second network structure is a fully convolutional network structure, for example, all feature processing layers in the network are convolutional layers.

If a network structure of the image detection model invoked by the computer device is the first network structure, the computer device may perform scaling on the to-be-detected image to scale an image size of the to-be-detected image to the fixed image size (for example, 48×48×3) supported for reception in the first network structure, and then may directly input the scaled to-be-detected image to the image detection model to perform image detection on the portion of the scaled to-be-detected image by using the image detection model, and then use a plurality of candidate boxes obtained through image detection as the candidate box set.

If a network structure of the image detection model invoked by the computer device is the second network structure, the computer device may directly input the to-be-detected image to the image detection model without taking a large amount of time, to perform image detection on the portion of the to-be-detected image by using the image detection model, and then use a plurality of candidate boxes obtained through image detection as the candidate box set.

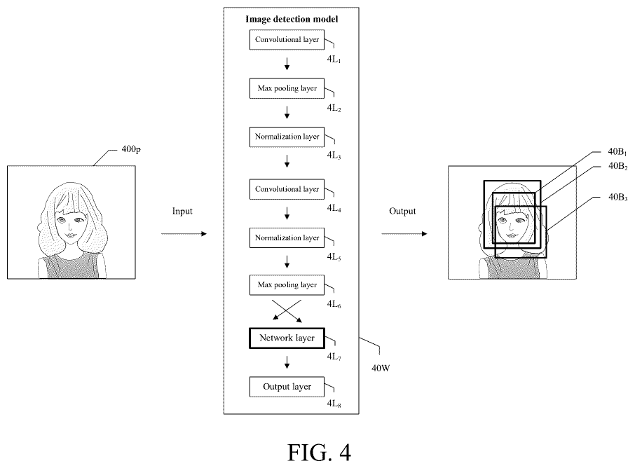

For ease of understanding, FIG. 4 is a schematic diagram of a scenario in which image detection is performed based on an image detection model according to some embodiments. As shown in FIG. 4, an image 400p is a to-be-recognized to-be-detected image obtained by a computer device in some embodiments. The computer device may be any terminal device in the terminal device cluster shown in FIG. 1, for example, the terminal device 100a, or the computer device may be the server 10F shown in FIG. 1. The computer device is not limited herein.

When obtaining the image 400p, the computer device may invoke an image detection model 40W shown in FIG. 4. The image detection model 40W may include a convolutional layer 4L₁, a max pooling layer 4L₂, a normalization layer 4L₃, a convolutional layer 4L₄, a normalization layer 4L₅, a max pooling layer 4L₆, a network layer 4L₇, and an output layer 4L₈. For example, 64 5×5 convolution kernels may be used at the convolutional layer 4L₁ and the convolutional layer 4L₄, with a step of 1; both a filter parameter of the max pooling layer 4L₂ and a filter parameter of the max pooling layer 4L₆ may be 3×3, with a step of 2; and the output layer 4L₈ may be a two-category output node, and may be configured to output a portion category or a non-salient category.

If the network layer 4L₇ is a fully connected layer, a network structure of the image detection model 40W is a first network structure, for example, a to-be-detected image with a fixed image size may be input. When obtaining the image 400p, the computer device is to perform scaling on the image 400p to scale an image size of the image 400p to the fixed image size (for example, 48×48×3) supported for reception in the first network structure, and then may directly input the scaled image 400p to the image detection model 40W to perform image detection on a portion of the scaled image 400p by using the image detection model 40W, and then may determine a plurality of candidate boxes output by the image detection model 40W as a candidate box set. The candidate box set may include a candidate box 40B₁, a candidate box 40B₂, and a candidate box 40B₃ shown in FIG. 4.

In some embodiments, if the network layer 4L₇ is a convolutional layer, a network structure of the image detection model 40W is a fully convolutional network structure. The computer device may determine that the network structure of the image detection model 40W is a second network structure. This means that the image detection model 40W may perform sliding detection on an image of any size by using a sliding window with a fixed step, to complete two tasks of image detection: bounding box detection (detection proposal) and classification.

The computer device may directly input the image 400p to the image detection model 40W to perform image detection on a portion of the scaled image 400p by using the image detection model 40W, and then may determine a plurality of candidate boxes output by the image detection model 40W as a candidate box set. The candidate box set may include a candidate box 40B₁, a candidate box 40B₂, and a candidate box 40B₃ shown in FIG. 4. The image detection model 40W can perform sliding window detection on an image of any size, and detect, to the maximum extent, a portion from the image with very high coverage. The image detection model adapts to task characteristics and can detect a portion of any size in an image of any size within very short time, to provide good pre-filtering for a subsequent process, improve overall operation efficiency of the system, and avoid a large quantity of ineffective calculations.

Operation 102: Deduplicate a candidate box in the candidate box set based on the to-be-detected image to obtain a to-be-processed box set, perform position correction on a candidate box in the to-be-processed box set to obtain an adjusted box, and generate, based on the adjusted box, an adjusted box set and a cropped image set corresponding to the adjusted box set.

The computer device may deduplicate the candidate box set according to a deduplication rule based on shape-adaptive non-maximum suppression (NMS) to obtain the to-be-processed box set, the to-be-processed box set herein including a candidate box Xᵢ, i being a positive integer less than or equal to H, and H being configured for indicating a total quantity of candidate boxes in the to-be-processed box set. The computer device may invoke an image offset adjustment model to perform position correction on the candidate box Xᵢ by using the to-be-detected image to obtain an adjusted box Yᵢ and a cropped image corresponding to the adjusted box Yᵢ. When obtaining H adjusted boxes, the computer device may further deduplicate the H adjusted boxes according to the deduplication rule, determine an adjusted box obtained through deduplication as the adjusted box set corresponding to the candidate box set, and determine a cropped image corresponding to the adjusted box obtained through deduplication as the cropped image set corresponding to the adjusted box set, the cropped image set including N cropped images, a cropped image being obtained by cropping the to-be-detected image based on an adjusted box in the adjusted box set, and N being a positive integer.

The image detection model can effectively detect a suspected portion (for example, a suspected human face) region in the to-be-detected image. Due to limitations of network performance and a training data size, the image detection model may incorrectly detect some regions similar to the portion as the portion. In a method of performing image detection by using a sliding window, duplicate facial regions appear inevitably. The computer device may further deduplicate the candidate box set according to the deduplication rule based on shape-adaptive NMS. The deduplication rule is configured for deduplicating candidate boxes, in the candidate box set, in which a suspected portion is located, to aggregate duplicate candidate boxes of the same object into one candidate box if possible while ensuring a recall rate.

NMS means extracting the most representative piece of data from a plurality of pieces of duplicate data and suppressing other duplicate data, for example, suppressing an element that is not a maximum value. This may be understood as a local maximum search. In the NMS algorithm, locally duplicate candidate boxes are filtered by using a condition, to obtain an optimal candidate box. The NMS algorithm is widely applied to object detection algorithms. In view of shape characteristics of a portion (for example, a human face), the portion is not a square with a length equal to a width, but is an approximate ellipse with a length slightly greater than a width. If an NMS algorithm is used to remove duplicate bounding boxes in which the portion is located, some human face boxes that are close to each other but actually indicate two different human faces may be removed. This is because many non-facial regions exist on a left side and a right side in a square face box, and these regions cause misjudgment of the NMS algorithm on an overlapping relationship between two face boxes. In some embodiments, a common NMS algorithm may be improved to obtain a shape-adaptive NMS algorithm, and then deduplication may be performed based on the algorithm.

If the candidate box set includes K candidate boxes, the computer device may separately crop each of the K candidate boxes based on an image cropping rate specified according to the deduplication rule based on shape-adaptive NMS to obtain K cropped boxes. Because the image detection model is further configured to determine a predicted category confidence respectively corresponding to each of the K candidate boxes, the computer device may sort the K cropped boxes based on K predicted category confidences to obtain a sorting result. The computer device may determine a cropped box with a highest predicted category confidence in the sorting result as a first cropped box, and determine (K-1) cropped boxes other than the first cropped box in the sorting result as a to-be-filtered set.

Then the computer device may deduplicate the K cropped boxes based on an overlapping degree between the first cropped box and each cropped box in the to-be-filtered set to obtain a retained box set. The computer device may separately determine the overlapping degree between the first cropped box and each cropped box in the to-be-filtered set. If the to-be-filtered set includes an overlapping cropped box with an overlapping degree greater than an overlapping degree threshold, the computer device may retain the first cropped box, and filter out the overlapping cropped box from the to-be-filtered set, and then may use a cropped box with a highest predicted category confidence in a to-be-filtered set obtained through filtering as a second cropped box, and use a cropped box other than the second cropped box as a new to-be-filtered set. Then the computer device may retain the second cropped box, and continue to deduplicate the new to-be-filtered set based on an overlapping degree between the second cropped box and each cropped box in the new to-be-filtered set until a to-be-filtered set obtained through deduplication is empty, and determine a retained cropped box as the retained box set, the retained box set including the first cropped box and the second cropped box.

For some embodiments of cropping, by the computer device, the candidate box set according to the deduplication rule based on shape-adaptive NMS, refer to the following formula (1):

$$\{ \begin{matrix}{x}_{1 \_ new} = {x}_{1} + 0.5 \times narrowrate \times ( {x}_{2} - {x}_{1} ) \\ {y}_{1 \_ new} = {y}_{1} \\ {x}_{2 \_ new} = {x}_{2} - 0.5 \times narrowrate \times ( {x}_{2} - {x}_{1} ) \\ {y}_{2 \_ new} = {y}_{2}\end{matrix} \qquad ( 1 )$$

(X₁, y₁) is coordinates of a first vertex (for example, coordinates of an upper-left corner) of a candidate box in the candidate box set. (X₂, y₂) is coordinates of a second vertex (for example, coordinates of a lower-right corner) in the candidate box that have a diagonal relationship with the coordinates of the first vertex. narrowrate is the image cropping rate specified by the deduplication rule, for example, 0.08. The image cropping rate is an optimal value obtained through a plurality of experiments.

For some embodiments, determining, by the computer device, an overlapping degree between any two bounding boxes (for example, a bounding box 1 and a bounding box 2), refer to the following formula (2):

$$IOU = \frac{{C}_{12}}{{U}_{12}} \qquad ( 2 )$$

C₁₂ indicates an overlapping area between the bounding box 1 and the bounding box 2. U₁₂ indicates an area of a union set between the bounding box 1 and the bounding box 2.

Finally, the computer device may separately perform image expansion on each cropped box in the retained box set based on the image cropping rate to obtain the to-be-processed box set. For some embodiments, performing, by the computer device, image expansion on a cropped box in the retained box set, refer to the following formula (3):

$$\{ \begin{matrix}{x}_{1 \_ new} = \frac{{x}_{1} + {x}_{2}}{2} - \frac{{x}_{2} - {x}_{1}}{2 * ( 1 - narrowrate )} \\ {y}_{1 \_ new} = {y}_{1} \\ {x}_{2 \_ new} = \frac{{x}_{1} + {x}_{2}}{2} + \frac{{x}_{2} - {x}_{1}}{2 * ( 1 - narrowrate )} \\ {y}_{2 \_ new} = {y}_{2}\end{matrix} \qquad ( 3 )$$

(X₁, y₁) is coordinates of a first vertex (for example, coordinates of an upper-left corner) of a cropped box in the retained box set. (X₂, y₂) is coordinates of a second vertex (for example, coordinates of a lower-right corner) in the cropped box that have a diagonal relationship with the coordinates of the first vertex. narrowrate may be the image cropping rate specified by the deduplication rule, for example, 0.08.

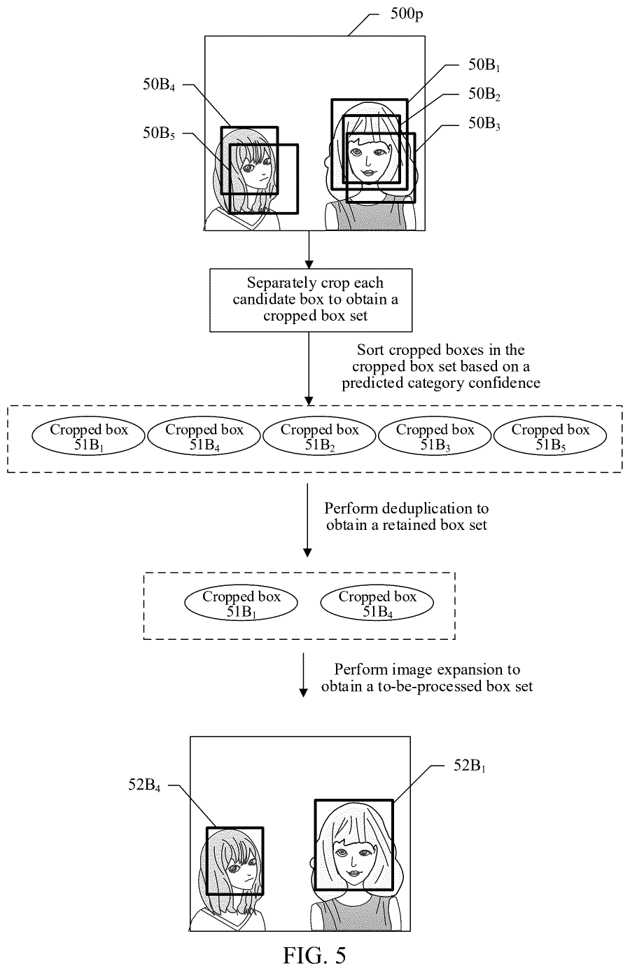

For ease of understanding, FIG. 5 is a schematic diagram of a scenario in which a candidate box set is deduplicated according to some embodiments. As shown in FIG. 5, an image 500p is a to-be-recognized to-be-detected image obtained by a computer device in some embodiments. The computer device may be any terminal device in the terminal device cluster shown in FIG. 1, for example, the terminal device 100a, or the computer device may be the server 10F shown in FIG. 1. The computer device is not limited herein.

As shown in FIG. 5, a candidate box set obtained by the computer device after the computer device performs operation 101 may include five candidate boxes, which may include a candidate box 50B₁, a candidate box 50B₂, a candidate box 50B₃, a candidate box 50B₄, and a candidate box 50B₅. The image detection model may further output a predicted category confidence corresponding to each of the five candidate boxes, which may include a predicted category confidence 1 (for example, 0.9) corresponding to the candidate box 50B₁, a predicted category confidence 2 (for example, 0.85) corresponding to the candidate box 50B₂, a predicted category confidence 3 (for example, 0.82) corresponding to the candidate box 50B₃, a predicted category confidence 4 (for example, 0.87) corresponding to the candidate box 50B₄, and a predicted category confidence 5 (for example, 0.81) corresponding to the candidate box 50B₅.

The computer device may separately crop (for example, perform a left-right cropping operation on) each of the five candidate boxes based on the formula (1) and the image cropping rate specified by the deduplication rule, to obtain a cropped box set. For example, the computer device may crop the candidate box 50B₁ based on the formula (1) and the image cropping rate to obtain a cropped box 51B₁ corresponding to the candidate box 50B₁. By analogy, the computer device may separately obtain a cropped box 51B₂ corresponding to the candidate box 50B₂, a cropped box 51B₃ corresponding to the candidate box 50B₃, a cropped box 51B₄ corresponding to the candidate box 50B₄, and a cropped box 51B₅ corresponding to the candidate box 50B₅.

The computer device may sort the five cropped boxes in the cropped box set based on the five predicted category confidences to obtain a sorting result. For example, the sorting result may be the cropped box 51B₁, the cropped box 51B₄, the cropped box 51B₂, the cropped box 51B₃, and the cropped box 51B₅ shown in FIG. 5. The computer device may determine a cropped box with a highest predicted category confidence in the sorting result as a first cropped box (for example, the cropped box 51B₁), and determine four cropped boxes in the sorting result other than the first cropped box as a to-be-filtered set (for example, the cropped box 51B₄, the cropped box 51B₂, the cropped box 51B₃, and the cropped box 51B₅).

The computer device may separately determine, based on the formula (2), an overlapping degree between the cropped box 51B₁ and each cropped box in the to-be-filtered set, which may include an overlapping degree (for example, 0) between the cropped box 51B₁ and the cropped box 51B₄, an overlapping degree (for example, 0.7) between the cropped box 51B₁ and the cropped box 51B₂, an overlapping degree (for example, 0.5) between the cropped box 51B₁ and the cropped box 51B₃, and an overlapping degree (for example, 0) between the cropped box 51B₁ and the cropped box 51B₅.

Then the computer device may determine, based on an overlapping degree threshold, whether an overlapping cropped box exists in the to-be-filtered set. The overlapping cropped box herein is a cropped box whose overlapping degree with the first cropped box reaches the overlapping degree threshold (for example, 0.4). The overlapping degree threshold may be dynamically adjusted based on a case, and is not limited.

Because both the overlapping degree between the cropped box 51B₁ and the cropped box 51B₂ and the overlapping degree between the cropped box 51B₁ and the cropped box 51B₃ reach the overlapping degree threshold, the computer device may determine the cropped box 51B₂ and the cropped box 51B₃ as overlapping cropped boxes, and then may retain the cropped box 51B₁ and filter out the overlapping cropped boxes from the to-be-filtered set to obtain a to-be-filtered set (for example, the cropped box 51B₄ and the cropped box 51B₅) through filtering.

Because the to-be-filtered set obtained through filtering is not empty, the computer device may continue to traverse the to-be-filtered set obtained through filtering, to determine whether an overlapping cropped box exists in the to-be-filtered set obtained through filtering. The computer device may use a cropped box with a highest predicted category confidence in the to-be-filtered set obtained through filtering as a second cropped box (for example, the cropped box 51B₄), and use a cropped box other than the second cropped box as a new to-be-filtered set (for example, the cropped box 51B₅).

Because one cropped box exists in the new to-be-filtered set, the computer device may determine an overlapping degree (for example, 0.8) between the cropped box 51B₄ and the cropped box 51B₅ based on the formula (2). Because the overlapping degree between the cropped box 51B₄ and the cropped box 51B₅ reaches the overlapping degree threshold, the computer device may determine the cropped box 51B₅ as an overlapping cropped box, and then may retain the cropped box 51B₄, and deduplicate the overlapping cropped box in the new to-be-filtered set. Because a to-be-filtered set obtained through deduplication is empty, it can be determined that the computer device has traversed all of the cropped box set. The computer device may determine the retained first cropped box (for example, the cropped box 51B₁) and the retained second cropped box (for example, the cropped box 51B₄) as a retained box set.

After filtering out the overlapping cropped boxes, the computer device may re-expand each cropped box in the retained box set to a square bounding box. For example, the computer device may perform image expansion on the cropped box 51B₁ based on the formula (3) and the image cropping rate to obtain a candidate box 52B₁ shown in FIG. 5. The computer device may perform image expansion on the cropped box 51B₄ based on the formula (3) and the image cropping rate to obtain a candidate box 52B₄ shown in FIG. 5. The computer device may determine the candidate box 52B₁ and the candidate box 52B₄ as a to-be-processed box set.

In some embodiments, the NMS algorithm is replaced with the shape-adaptive NMS algorithm, to avoid NMS misoperation to some extent. According to the deduplication rule based on shape-adaptive NMS, duplicate candidate boxes in the candidate box set can be deduplicated, to retain one or more most representative candidate boxes. Because the deduplication rule is optimized in a shape-adaptive manner based on a special shape of a portion (for example, a human face), the optimization better adapts to service characteristics, and the deduplication rule can retain face boxes of different objects that are excessively close to each other while effectively deduplicating face boxes belonging to the same object. This greatly reduces a quantity of face boxes that may be processed in a subsequent process, and ensures detection coverage.

The computer device may invoke the image offset adjustment model to perform offset prediction on each candidate box in the to-be-processed box set to iteratively correct a position of each candidate box. A model body structure of the image offset adjustment model herein may be implemented based on a convolutional neural network, an attention model, or the like. The model body structure of the image offset adjustment model is not limited herein.

A model input of the image offset adjustment model is the to-be-detected image and a coordinate position of region coordinates in which each candidate box in the to-be-processed box set is located (for example, a coordinate position of the candidate box). A model output of the image offset adjustment model is a candidate box on which position correction has been performed (for example, an adjusted box). The image offset adjustment model may output coordinates of a region in which the adjusted box is located, and a format of a coordinate position of the adjusted box is [x, y, w, h], x and y being coordinates of a vertex (for example, coordinates of an upper-left corner) of the adjusted box, w being a width corresponding to the adjusted box, and h being a height corresponding to the adjusted box.

For example, the computer device may invoke the image offset adjustment model, and then may perform offset prediction on a candidate box Xᵢ by using the to-be-detected image to obtain a first regression parameter. Then the computer device may perform position correction on the candidate box Xᵢ based on the first regression parameter to obtain a first adjusted box corresponding to the candidate box Xᵢ, and then may determine, based on a relationship between the first regression parameter and a regression parameter threshold range, whether to end adjustment. The regression parameter threshold range herein may be dynamically adjusted according to an actual requirement, and is not limited herein. For example, the regression parameter threshold range may be [−2, 2].

If the first regression parameter belongs to the regression parameter threshold range, the computer device may determine to end adjustment, and then may directly determine the first adjusted box corresponding to the candidate box Xᵢ as an adjusted box Yᵢ corresponding to the candidate box Xᵢ. In some embodiments, if the first regression parameter does not belong to the regression parameter threshold range, the computer device may determine that position correction further may be performed on the first adjusted box. The computer device may invoke the image offset adjustment model to perform, by using the to-be-detected image, offset prediction on the first adjusted box corresponding to the candidate box Xᵢ, to obtain a second regression parameter; and then may adjust, based on the second regression parameter, the first adjusted box corresponding to the candidate box Xᵢ, to obtain a second adjusted box corresponding to the candidate box Xᵢ. If the second regression parameter belongs to the regression parameter threshold range, the computer device determines the second adjusted box corresponding to the candidate box Xᵢ as an adjusted box Yᵢ corresponding to the candidate box Xᵢ, and then may crop the to-be-detected image based on a coordinate position of the adjusted box Yᵢ to obtain a cropped image corresponding to the adjusted box Yᵢ.

For some embodiments, adjusting, by the computer device, a candidate box based on a regression parameter (for example, bbr), refer to the following formulas (4) and (5):

$$bbr = [ {x}_{offset} , {y}_{offset} , {w}_{offset} , {h}_{offset} ] \qquad ( 4 )$$

$$\{ \begin{matrix}x = {x}_{0} + {x}_{offset} \\ y = {y}_{0} + {y}_{offset} \\ w = {w}_{0} + {w}_{offset} \\ h = {h}_{0} + {h}_{offset}\end{matrix} \qquad ( 5 )$$

x₀ and y₀ are configured for indicating coordinates of a vertex (for example, coordinates of an upper-left corner) of a current candidate box. w₀ is a width corresponding to the candidate box. h₀ is a height corresponding to the candidate box. bbr is a regression parameter obtained by performing offset prediction on a coordinate position of the current candidate box by using the image offset adjustment model. X_{offset} is a predicted offset obtained for a corresponding coordinate (for example, a horizontal coordinate) of X₀. Y_{offset} is a predicted offset obtained for a corresponding coordinate (for example, a vertical coordinate) of y₀. W_{offset} is a predicted offset obtained for the width. h_{offset} is a predicted offset obtained for the height.

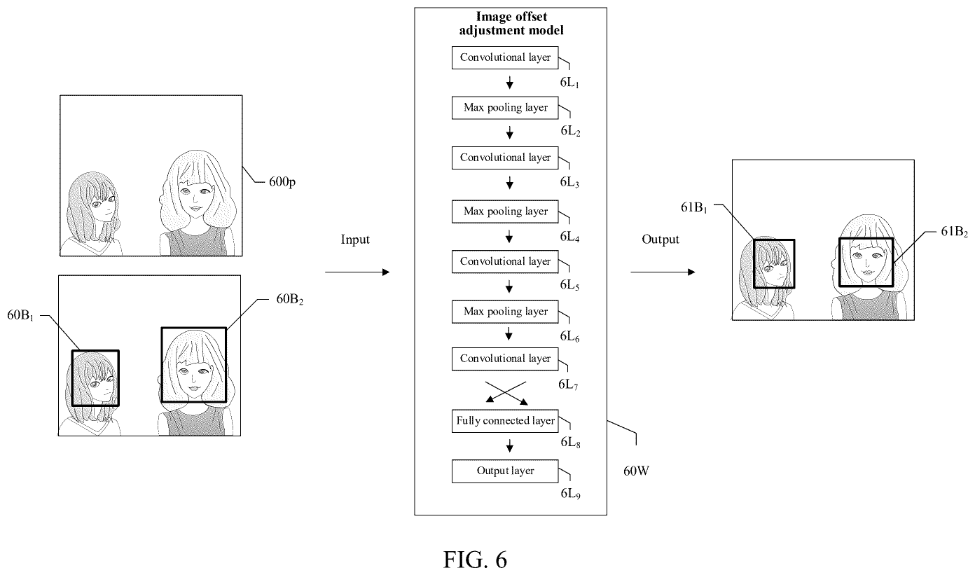

For ease of understanding, FIG. 6 is a schematic diagram of a scenario in which position correction is performed based on an image offset adjustment model according to some embodiments. As shown in FIG. 6, an image 600p is a to-be-recognized to-be-detected image obtained by a computer device in some embodiments. Both a candidate box 60B₁ and a candidate box 60B₂ in a to-be-processed box set are obtained by the computer device by deduplicating a candidate box set.

As shown in FIG. 6, after deduplicating the candidate box set, the computer device may invoke an image offset adjustment model 60W. For example, a network structure of the image offset adjustment model 60W is different from that of the image detection model, and difficulty in an offset mode classification task is higher than that in a portion classification task. A plurality of convolution operations are added to the network, to extract a feature with stronger expressiveness. The image offset adjustment model 60W may receive a 48×48×3 data input, and output a 45-category offset mode classification result.

As shown in FIG. 6, the image offset adjustment model 60W may include a convolutional layer 6L₁, a max pooling layer 6L₂, a convolutional layer 6L₃, a max pooling layer 6L₄, a convolutional layer 6L₅, a max pooling layer 6L₆, a convolutional layer 6L₇, a fully connected layer 6L₈, and an output layer 6L₉. For example, 32 3×3 convolution kernels may be used at the convolutional layer 6L₁, with a step of 1; a filter parameter of the max pooling layer 6L₂ may be 3×3, with a step of 2; 64 3×3 convolution kernels may be used at the convolutional layer 6L₃, with a step of 1; a filter parameter of the max pooling layer 6L₄ may be 3×3, with a step of 1; 64 3×3 convolution kernels may be used at the convolutional layer 6L₅, with a step of 1; a filter parameter of the max pooling layer 6L₆ may be 2×2, with a step of 2; 128 2×2 convolution kernels may be used at the convolutional layer 6L₇, with a step of 1; an output size of the fully connected layer 6L₈ may be 1×256; and the output layer 6L₉ may be a 45-category output node, for example, is configured to output 45 offset mode categories.

The computer device may directly input the two candidate boxes in the to-be-processed box set and the image 600p to the image offset adjustment model 60W, to separately perform offset prediction on the two candidate boxes to obtain predicted regression parameters respectively corresponding to the two candidate boxes.

For ease of understanding, Table 1 is an offset adjustment table determined based on an image offset adjustment model according to some embodiments. In the offset adjustment table shown in Table 1, results of two dimensions may be included for any candidate box. One is a predicted category confidence of the candidate box that is determined by the image offset adjustment model, and the other is a regression parameter of the candidate box that is determined by the image offset adjustment model. Details are shown in Table 1.

TABLE 1

| Predicted category | Coordinate position | Predicted regression |
|---|---|---|
| confidence | of the | parameter of |
| of a candidate | candidate | the candidate |
| box | box | box |
| Confidence 1 of the candidate | [x₁, y₁, w₁, h₁] | bbr1: [10, −12, 4, 7] |
| box 60B₁ | | |
| Confidence 2 of the candidate | [x₂, y₂, w₂, h₂] | bbr2: [1, 0, 2, 9] |
| box 60B₂ | | |

For example, for the candidate box 60B₁, a coordinate position of the candidate box 60B₁ is [x₁, y₁, W₁, h₁], and a predicted regression parameter of the candidate box 60B₁ is bbr1. The computer device may perform position correction on the coordinate position of the candidate box 60B₁ based on the formula (5) and the regression parameter bbr1 (for example, a first regression parameter), and then may determine a position-corrected candidate box 60B₁ as a first adjusted box corresponding to the candidate box 60B₁.

Due to complexity of a bounding box in which a portion is located, performing position fine-adjustment once may not achieve optimal effect. The computer device may determine, based on the first regression parameter, whether to input the first adjusted box to the image offset adjustment model 60W shown in FIG. 6 again for next fine adjustment (for example, position correction). In some embodiments, position correction is cyclically and iteratively performed on a candidate box to achieve more precise localization, so that a finally obtained adjusted box has very high localization accuracy. A small portion can be accurately localized, and adjacent or partially overlapping portions can be effectively distinguished.

It can be learned from Table 1 that the regression parameter bbr1 does not belong to the regression parameter threshold range. The computer device may input the first adjusted box corresponding to the candidate box 60B₁ to the image offset adjustment model 60W shown in FIG. 6 again, to perform offset prediction on the first adjusted box corresponding to the candidate box 60B₁ again by using the image 600p, to obtain a new predicted regression parameter (for example, a second regression parameter); and then may adjust, based on the second regression parameter, the first adjusted box corresponding to the candidate box 60B₁, to obtain a second adjusted box corresponding to the candidate box 60B₁, until a new predicted regression parameter belongs to the regression parameter threshold range. It is considered that fine adjustment (position correction) may not be performed. A finally output adjusted box (for example, the second adjusted box) may be determined as an adjusted box (for example, an adjusted box 61B₁ shown in FIG. 6) corresponding to the candidate box 60B₁. The computer device may crop the image 600p based on the adjusted box 61B₁ to obtain a cropped image corresponding to the adjusted box 61B₁.

In some embodiments, with reference to the implementation of performing offset adjustment on the candidate box 60B₁, offset adjustment may be performed on the candidate box 60B₂ to obtain an adjusted box (for example, an adjusted box 61B₂ shown in FIG. 6) corresponding to the candidate box 60B₂ and a cropped image corresponding to the adjusted box 61B₂.

To effectively ensure accuracy of a bounding box in which a portion is located, during deduplication (for example, first deduplication) of a candidate box set, a loose parameter may be used (for example, an overlapping degree threshold is set to a large value). Two candidate boxes that overlap to some extent may still exist among H candidate boxes in a to-be-processed box set obtained through the first deduplication. After offset adjustment is performed by using the image offset adjustment model, candidate boxes in which portions of two different objects are located are adjusted to be further away from each other, and candidate boxes in which portions of two same objects are located are adjusted to be closer to each other. This means that overlapping adjusted boxes may still exist in an adjusted to-be-processed box set. To effectively improve efficiency of subsequent detection, when obtaining H adjusted boxes, the computer device may perform deduplication again, and then may determine an adjusted box obtained through deduplication as an adjusted box set corresponding to the candidate box set, and determine a cropped image corresponding to the adjusted box obtained through deduplication as a cropped image set corresponding to the adjusted box set, to use the cropped image set as an input of a next model (for example, an image recognition and segmentation model).

Operation 103: Separately perform recognition and segmentation on each of the N cropped images to obtain a segmentation result associated with the portion.

The computer device may determine a to-be-processed image from the N cropped images, and then may invoke the image recognition and segmentation model to perform recognition on the to-be-processed image by using an image classification branch in the image recognition and segmentation model to obtain a predicted category confidence corresponding to the to-be-processed image, and then eliminate a non-salient portion of the to-be-processed image by using an image segmentation branch in the image recognition and segmentation model to obtain a segmented image corresponding to the to-be-processed image. If the predicted category confidence corresponding to the to-be-processed image is greater than a confidence threshold, it is considered that the to-be-processed image belongs to a portion category. The computer device may determine the segmented image corresponding to the to-be-processed image as the segmentation result associated with the portion. The segmentation result includes M segmented images, and M is a positive integer less than or equal to N.

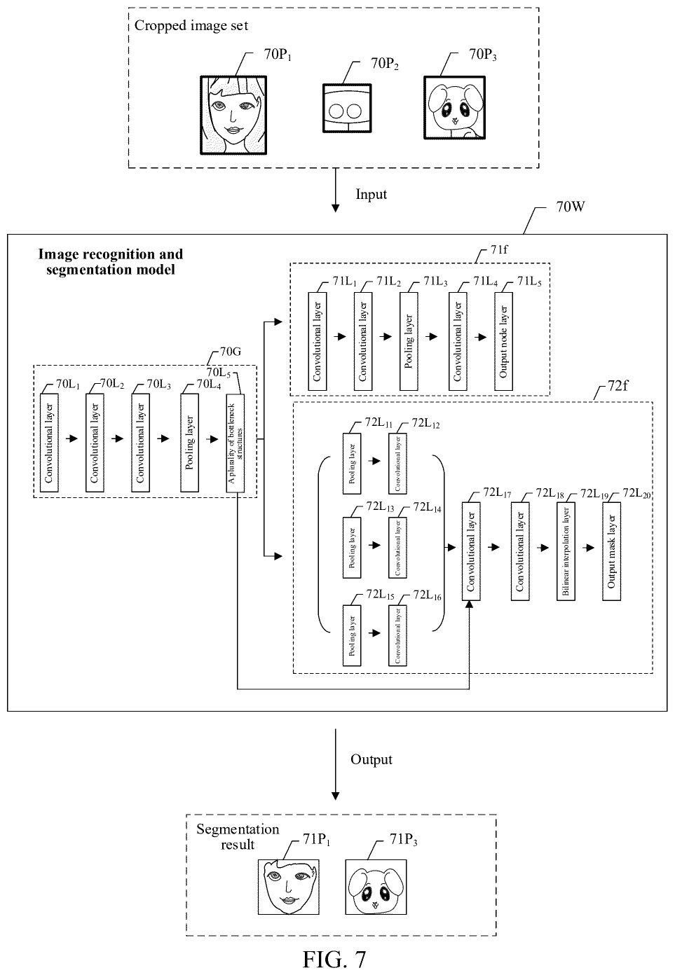

For ease of understanding, FIG. 7 is a schematic diagram of a scenario in which recognition and segmentation are performed based on an image recognition and segmentation model according to some embodiments. As shown in FIG. 7, a cropped image set may include N cropped images, N being a positive integer, and a cropped image being obtained by the computer device by cropping a to-be-detected image based on an adjusted box in an adjusted box set. For ease of description, for example, N herein may be 3, and the cropped images may include a cropped image 70P₁, a cropped image 70P₂, and a cropped image 70P₃. The to-be-detected image herein may be the image 200p shown in FIG. 2. The cropped image 70P₁ is obtained by the computer device by cropping the image 200p based on the adjusted box 22B₁ shown in FIG. 2, the cropped image 70P₂ is obtained by the computer device by cropping the image 200p based on the adjusted box 22B₂ shown in FIG. 2, and the cropped image 70P₃ is obtained by the computer device by cropping the image 200p based on the adjusted box 22B₃ shown in FIG. 2.

To learn of more detailed information and distinguish a bounding box that cannot be correctly detected in the foregoing two operations, the image recognition and segmentation model invoked in some embodiments may include a public network layer and a multitasking branch. The public network layer herein may include a plurality of convolutional layers and a plurality of residual bottleneck structures, and all pooling layers in the image recognition and segmentation model may be average pooling layers.

As shown in FIG. 7, an image recognition and segmentation model 70W herein may include a public network layer 70G, an image classification branch 71f, and an image segmentation branch 72f. The public network layer 70G may include a convolutional layer 70L₁, a convolutional layer 70L₂, a convolutional layer 70L₃, a pooling layer 70L₄, and a plurality of bottleneck structures 70L₅. For example, 64 3×3 convolution kernels may be used at the convolutional layer 70L₁, with a step of 2; 64 3×3 convolution kernels may be used at the convolutional layer 70L₂, with a step of 1; 128 3×3 convolution kernels may be used at the convolutional layer 70L₃, with a step of 1; and a filter parameter of the pooling layer 70L₄ may be 3×3, with a step of 2. For example, the plurality of bottleneck structures herein may be four bottleneck structures. Table 2 is a schematic table of parameters of a bottleneck structure group according to some embodiments. Details are shown in Table 2.

TABLE 2

| | Convolutional layer 1 | | | Convolutional layer 2 | | | Convolutional layer 3 | | |
|---|---|---|---|---|---|---|---|---|---|
| | Convolution | | | Convolution | | | Convolution | | |
| Parameter | kernel | Step | Depth | kernel | Step | Depth | kernel | Step | Depth |
| Bottleneck | 1 × 1 | 2 | 128 | 3 × 3 | 1 | 128 | 1 × 1 | 1 | 512 |
| structure 1 | | | | | | | | | |
| Bottleneck | 1 × 1 | 1 | 128 | 3 × 3 | 1 | 128 | 1 × 1 | 1 | 512 |
| structure 2 | | | | | | | | | |
| Bottleneck | 1 × 1 | 1 | 128 | 3 × 3 | 1 | 128 | 1 × 1 | 1 | 512 |
| structure 3 | | | | | | | | | |
| Bottleneck | 1 × 1 | 1 | 128 | 3 × 3 | 1 | 128 | 1 × 1 | 1 | 512 |
| structure 4 | | | | | | | | | |

The image classification branch may include a convolutional layer 71L₁, a convolutional layer 71L₂, a pooling layer 71L₃, a convolutional layer 71L₄, and an output node layer 71L₅. For example, 512 3×3 convolution kernels may be used at the convolutional layer 71L₁ and the convolutional layer 71L₂, with a step of 2; a filter parameter of the pooling layer 71L₃ may be 7×7, with a step of 7; two 1×1 convolution kernels may be used at the convolutional layer 71L₄, with a step of 1; and The output node layer 71L₅ may be a two-category output node, is configured to output a portion category or a non-salient category.

The image segmentation branch 72f may include a pooling layer 72L₁₁, a convolutional layer 72L₁₂, a pooling layer 72L₁₃, a convolutional layer 72L₁₄, a pooling layer 72L₁₅, a convolutional layer 72L₁₆, a convolutional layer 72L₁₇, a convolutional layer 72L₁₈, a bilinear interpolation layer 72L₁₉, and an output mask layer 72L₂₀. For example, a filter parameter of the pooling layer 72L₁₁ may be 5×5, with a step of 5; 512 1×1 convolution kernels may be used at the convolutional layer 72L₁₂, with a step of 1; a filter parameter of the pooling layer 72L₁₃ may be 10×10, with a step of 10; 512 1×1 convolution kernels may be used at the convolutional layer 72L₁₄, with a step of 1; a filter parameter of the pooling layer 72L₁₅ may be 14×14, with a step of 14; 512 1×1 convolution kernels may be used at the convolutional layer 72L₁₆, with a step of 1; 512 3×3 convolution kernels may be used at the convolutional layer 72L₁₇, with a step of 1; and two 1×1 convolution kernels may be used at the convolutional layer 72L₁₈, with a step of 1. In the image segmentation branch, a multi-size pooling operation is performed on feature maps obtained from the public network layer. Then these feature maps are connected, and re-interpolation is performed on the feature maps by using a bilinear interpolation method to obtain an image with the same size as that of an input image. A segmentation mask image of the image is obtained. Then the segmentation mask image may be determined as a segmented image corresponding to the input image.

For example, the computer device may separately determine the cropped images in the cropped image set shown in FIG. 7 as to-be-processed images. For example, the computer device may input the cropped image 70P₁ to the image recognition and segmentation model 70W shown in FIG. 7. Recognition is performed on the cropped image 70P₁ by using the image classification branch 71f to obtain a predicted category confidence (for example, 0.9) corresponding to the cropped image 70P₁. A non-salient portion of the cropped image 70P₁ is eliminated by using the image segmentation branch 72f to obtain a segmented image corresponding to the cropped image 70P₁.

The computer device may input the cropped image 70P₂ to the image recognition and segmentation model 70W. Recognition is performed on the cropped image 70P₂ by using the image classification branch 71f to obtain a predicted category confidence (for example, 0.3) corresponding to the cropped image 70P₂. A non-salient portion of the cropped image 70P₂ is eliminated by using the image segmentation branch 72f to obtain a segmented image corresponding to the cropped image 70P₂.

The computer device may input the cropped image 70P₃ to the image recognition and segmentation model 70W. Recognition is performed on the cropped image 70P₃ by using the image classification branch 71f to obtain a predicted category confidence (for example, 0.87) corresponding to the cropped image 70P₃. A non-salient portion of the cropped image 70P₃ is eliminated by using the image segmentation branch 72f to obtain a segmented image corresponding to the cropped image 70P₃.

Because both the predicted category confidence corresponding to the cropped image 70P₁ and the predicted category confidence corresponding to the cropped image 70P₃ are greater than a confidence threshold (for example, 0.8), the computer device may determine that both the cropped image 70P₁ and the cropped image 70P₃ belong to a portion category. The computer device may determine both the segmented image (for example, a segmented image 71P₁ shown in FIG. 7) corresponding to the cropped image 70P₁ and the segmented image (for example, a segmented image 71P₃ shown in FIG. 7) corresponding to the cropped image 70P₃ as a segmentation result associated with a portion.

The image recognition and segmentation model 70W can output both a pixel-level image segmentation result and a macroscopic image detection result. In some embodiments, macroscopic image information of a classification task and microscopic pixel information of a segmentation task can be fully utilized, to learn of a feature with more comprehensive expressiveness. Overall effect of an algorithm process can be improved through multitasking, and very high accuracy can be ensured while two types of capabilities are output.

Operation 104: Separately correct, based on coordinate positions of the M segmented images, adjusted boxes in the adjusted box set that correspond to the M segmented images, to obtain M corrected boxes for indicating the portion of the to-be-detected image.

When obtaining the M segmented images in the segmentation result, the computer device may determine, from the adjusted box set, the adjusted boxes respectively corresponding to the M segmented images, and then may correct coordinate positions of the determined adjusted boxes based on the coordinate positions of the segmented images, to obtain the M corrected boxes for indicating the portion of the to-be-detected image.

As shown in FIG. 2, the computer device may determine, from the adjusted box set, that an adjusted box corresponding to the segmented image P₁ is the adjusted box 22B₁, and then may correct the adjusted box 22B₁ based on the coordinate position of the segmented image P₁ to obtain the corrected box 23B₁. The computer device may further determine, from the adjusted box set, that an adjusted box corresponding to the segmented image P₂ is the adjusted box 22B₃, and then may correct the adjusted box 22B₃ based on the coordinate position of the segmented image P₂ to obtain the corrected box 23B₃. This means that, after correcting the adjusted box set based on the two segmented images in the segmentation result, the computer device in some embodiments can accurately obtain two bounding boxes (for example, corrected boxes) for indicating the portion of the image 200p, faces of two different service objects exist in the image 200p.

In some embodiments, an end-to-end closed-loop design of image detection and segmentation is completed by using a concatenated model group formed by connecting the image detection model, the deduplication rule based on shape-adaptive NMS, the image offset adjustment model, and the image recognition and segmentation model in series. In this image detection method, through deduplication and offset adjustment (including deduplication and position correction) and a comprehensive consideration of an internal relationship between an image detection task and an image segmentation task, great importance is attached to a localization accuracy indicator of the bounding box in which the portion is located, to obtain the corrected box that can more precisely indicate the portion of the to-be-detected image, so that accuracy of image detection is effectively improved.

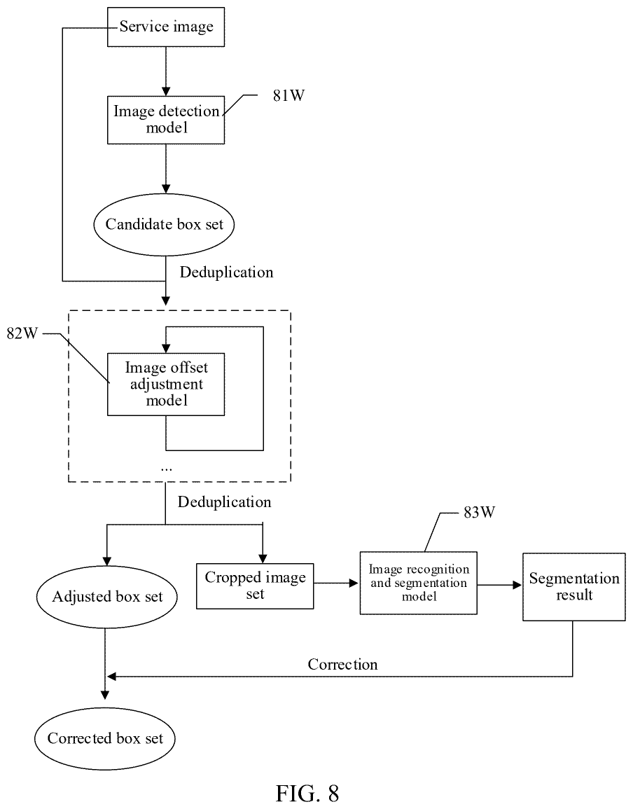

FIG. 8 is a schematic diagram of an image detection framework according to some embodiments. As shown in FIG. 8, some embodiments provides a closed-loop architecture of an iterative localization-type image detection and segmentation solution based on deep learning. The architecture may include a quick image detection stage, an iterative localization box offset correction stage, and a multitasking image detection and segmentation stage.

In the quick image detection stage, when obtaining a to-be-detected image, the computer device may input the to-be-detected image to an image detection model 81W shown in FIG. 8, and then may obtain, at a high recall rate from the to-be-detected image by using the image detection model 81W, a large quantity of localization boxes (for example, candidate boxes) in which a suspected portion is located, to provide quick and good pre-filtering for a subsequent image detection process. For example, image detection is performed on a portion of the to-be-detected image to obtain a candidate box set including a plurality of candidate boxes.

Because the candidate box set may include overlapping candidate boxes, in the iterative localization box offset correction stage, the computer device may perform intelligent deduplication on the candidate box set according to a deduplication rule based on shape-adaptive NMS, to retain one or more most effective candidate boxes, and reduce an amount of subsequent calculation. The computer device may input both a deduplicated candidate box set (for example, a to-be-processed box set) and the to-be-detected image to an image offset adjustment model 82W to iteratively perform position offset fine-adjustment (for example, position correction) on H candidate boxes in the to-be-processed box set, until H bounding boxes for example, adjusted boxes) for indicating optimal localization of each portion are obtained, H being a positive integer. To improve efficiency of subsequent detection, the computer device may deduplicate the H candidate boxes again to obtain an adjusted box set and a cropped image set corresponding to the adjusted box set. Each cropped image in the cropped image set herein is obtained by cropping the to-be-detected image based on an adjusted box in the adjusted box set.

In the multitasking image detection and segmentation stage, the computer device may perform image classification and image segmentation on a remaining bounding box (for example, an adjusted box in the adjusted box set) again, to output both a bounding box in which a portion of a category set is located, and a pixel-level background-removed segmented image. For example, the computer device may separately input N cropped images in the cropped image set to an image recognition and segmentation model 83W shown in FIG. 8, to determine, by using an image classification branch and an image segmentation branch in the image recognition and segmentation model 83W, a segmented image belonging to a portion category, so that a segmentation result associated with the portion can be obtained. The segmentation result herein may include M segmented images, M is a positive integer less than or equal to N, and Nis a positive integer less than or equal to H.

Finally, the computer device may separately correct adjusted boxes in the adjusted box set that correspond to the M segmented images, to obtain a corrected box set. The corrected box set herein may include M corrected boxes for indicating the portion of the to-be-detected image.

An input of a detection system corresponding to the detection framework shown in FIG. 8 may be a to-be-detected image on which detection may be performed, and an output of the system may indicate whether a portion (for example, a human face) exists in a current to-be-detected image. If a portion exists, a bounding box (for example, a corrected box) in which the portion is located and a pixel-level foreground image (for example, a background-removed segmented image) corresponding to each corrected box are output. Due to impact of diversity of portions, a change in an angle of view, an illumination condition, occlusion, and a complex background, the image detection model 81W, the deduplication rule, the image offset adjustment model 82W, and the image recognition and segmentation model 83W in some embodiments are designed through customization based on portions. The framework in some embodiments can be transferred to more image object detection tasks through customization. During image detection based on the framework, quick detection can be implemented on a complex portion of a to-be-detected image, with low implementation/operation costs, a high recognition recall rate/precision, and superb online performance.

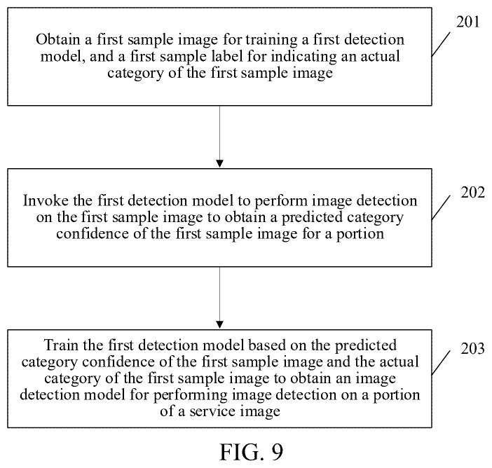

FIG. 9 is a schematic flowchart of a training method for an image detection model according to some embodiments. The method may be performed by a computer device with a model training function. The computer device may be a terminal device (for example, any terminal device in the terminal device cluster shown in FIG. 1, for example, the terminal device 100a), or may be a server with a model training function (for example, the server 10F shown in FIG. 1). This is not limited herein. The method may include at least the following operation 201 to operation 203:

Operation 201: Obtain a first sample image for training a first detection model, and a first sample label for indicating an actual category of the first sample image.

For a network structure of the first detection model, refer to the network structure shown in FIG. 4. The first detection model may include two convolutional layers, two pooling layers, two normalization layers, one special network layer (for example, a network layer 4L₇), and a final output layer (label layer). The first sample image is obtained by preprocessing a portion of a raw sample image. For example, if the portion is a human face, the raw sample image herein may be a face image in a face database (for example, Annotated Facial Landmarks in the Wild, referred to as a face dataset). When obtaining the raw sample image, the computer device may generate a face/non-face training set through local segmentation, flipping, Gaussian blurring, or the like.

Operation 202: Invoke the first detection model to perform image detection on the first sample image to obtain a predicted category confidence of the first sample image for the portion.

Operation 203: Train the first detection model based on the predicted category confidence of the first sample image and the actual category of the first sample image to obtain an image detection model for performing image detection on a portion of a to-be-detected image.

The computer device may perform loss calculation on the predicted category confidence of the first sample image and the actual category of the first sample image to determine a model loss of the first detection model, and then may train the first detection model based on the model loss of the first detection model to obtain a first model training result. If the first model training result indicates that a trained first detection model meets a first model convergence condition, the computer device may use the first detection model that meets the first model convergence condition as a second detection model, and then may perform structural analysis on a network structure of the second detection model to obtain an analysis result, and generate, based on the analysis result and the second detection model, the image detection model for performing image detection on the portion of the to-be-detected image.

If the network structure of the first detection model designed in some embodiments is a first network structure (a network structure when the network layer 4L₇ shown in FIG. 4 is a fully connected layer), the computer device may train the first detection model to obtain the first detection model (for example, the second detection model) that meets the model convergence condition, and may directly use the second detection model as a final image detection model.

An objective of training the first detection model is to minimize a loss function, minimize a difference between a predicted label and a true label through network training, the difference being referred to as a loss. There are a plurality of types of loss functions. For a classification task, in some embodiments, a loss function obtained by combining a cross-entropy loss function and a regularization term may be used. Refer to the following formulas (6) to (8):

$$J ( w ) = \frac{1}{N} {\sum }_{i = 1}^{N} L ( {y}_{i} , {p}_{i} ) + λ R ( w ) \qquad ( 6 )$$

N herein is a quantity of samples in each iteration, for example, a batch-size. L (yᵢ, pᵢ) is a loss value of an i^{th} sample image in the first sample image. 2 controls a weight of a regularization term. R is the regularization term. w is a weight value.

$$L ( {y}_{i} , {p}_{i} ) = - {\sum }_{j = 1}^{C} {y}_{ij} log ( {p}_{ij} ) \qquad ( 7 )$$

C is a total quantity of categories (for example, 2, for example, a portion and a non-salient portion). yᵢⱼ is a true category confidence, determined from the first sample label, of the i^{th} sample image in the first sample image belonging to a category j (for example, the portion category). pᵢⱼ is a predicted category confidence, determined by the first detection model, of the i^{th} sample image belonging to the category j (for example, the portion category).

$$R ( w ) = {\sum }_{k = 1}^{K} {w}_{k}^{2} \qquad ( 8 )$$

K is a quantity of weights, and Wₖ is a k^{th} weight among the k weights.

The cross-entropy loss function measures a difference between different distributions, and has good effect for measuring whether two types of tasks in some embodiments belong to a portion. A regularization loss function represents a sum of squares of weights, and can effectively suppress a weight range, to improve model generality.

After the first sample image is input to the first detection model whose network structure is the first network structure, the computer device may determine the model loss of the first detection model based on the formulas (6) to (8), and then may train the first detection model based on the model loss and a model convergence condition (for example, the first model convergence condition) corresponding to the first detection model, to obtain the first model training result. The first model convergence condition herein is that a current model loss reaches or exceeds a specified threshold or a quantity of training steps reaches or exceeds a specified threshold.

If the first model training result indicates that the trained first detection model meets the first model convergence condition, the computer device may use the first detection model that meets the first model convergence condition as the second detection model, and then may directly use the second detection model as the image detection model for performing image detection on the portion of the to-be-detected image.

In some embodiments, if the network structure of the first detection model designed in some embodiments is the first network structure, the finally obtained second detection model includes a fully connected layer. Because an input sample image may be traversed by using a sliding window method during image detection, the entire process takes a large amount of time. For a formula about a quantity of times of classification, refer to the following formula (9):

$$C = ( \frac{L - S}{S} + 1 ) \times ( \frac{W - S}{S} + 1 ) \qquad ( 9 )$$

L is configured for representing a length of an input image, W is configured for representing a width of the input image, and S is configured for representing a sliding step of a sliding window.

Assuming that a size of an input sample image is 800×600 and a sliding step is 32, it can be determined, based on the formula (9), that a quantity of times of classification for the input sample image is 450. To detect portions of different sizes, the input sample image is further scaled to different sizes and then input to the network again. This further increases a quantity of times of classification required. Actually, adjacent windows partially overlap during image detection based on a sliding window, and calculation is repeatedly performed on this part of overlapping images for a plurality of times during sliding calculation, leading to an unnecessary waste of calculation resources. To overcome this problem, in some embodiments, after the second detection model including the fully connected layer is obtained through training, the second detection model including the fully connected layer may be converted into a fully convolutional network, and a second detection model obtained through conversion is determined as a final image detection model.

For example, when the analysis result indicates that the second detection model includes the fully connected layer, the computer device may replace the fully connected layer in the second detection model with a first convolutional layer configured with a sliding step, and then may assign a value to the first convolutional layer based on a network parameter of the fully connected layer to obtain a second convolutional layer, and determine a second detection model including the second convolutional layer as the image detection model for performing image detection on the portion of the to-be-detected image. Before being converted into the fully convolutional network, the model supports inputting of a picture with a fixed image size (for example, 48×48×3). After being converted into the fully convolutional network, the model supports inputting of a picture with any image size.

In some embodiments, if the network structure of the first detection model designed in some embodiments is the second network structure (a network structure when the network layer 4L₇ shown in FIG. 4 is a convolutional layer), the computer device may determine that an analysis result of the first detection model meeting the first model convergence condition (for example, the second detection model) indicates that the second detection model is a fully convolutional network. The computer device may perform image detection on an image of any size. The computer device may also directly determine the second detection model that is a fully convolutional network as a final image detection model.

The image detection model (for example, the image detection model 81W shown in FIG. 8) in some embodiments may include three cases. In one case, the image detection model is obtained by directly training the first detection model belonging to the first network structure. In another case, the image detection model is obtained by training the first detection model belonging to the first network structure and then converting a trained first detection model into a fully convolutional network. In still another case, the image detection model is obtained by directly training the first detection model belonging to the second network structure. A training process of the image detection model is not limited herein. The trained image detection model in some embodiments is configured to perform operation 101 in some embodiments corresponding to FIG. 3. When a to-be-detected image is obtained, image detection is performed on a portion of the to-be-detected image by using the image detection model, to obtain a candidate box set.

In some embodiments, a solution of an image detection model based on a fully convolutional network is provided. In this solution, sliding window detection may be performed on an image of any size, to detect, to the maximum extent, a portion from the image with very high coverage. This design adapts to task characteristics and can detect a portion of any size in an image of any size within very short time, to provide good pre-filtering for a subsequent process, improve overall operation efficiency of the system, and avoid a large quantity of ineffective calculations.

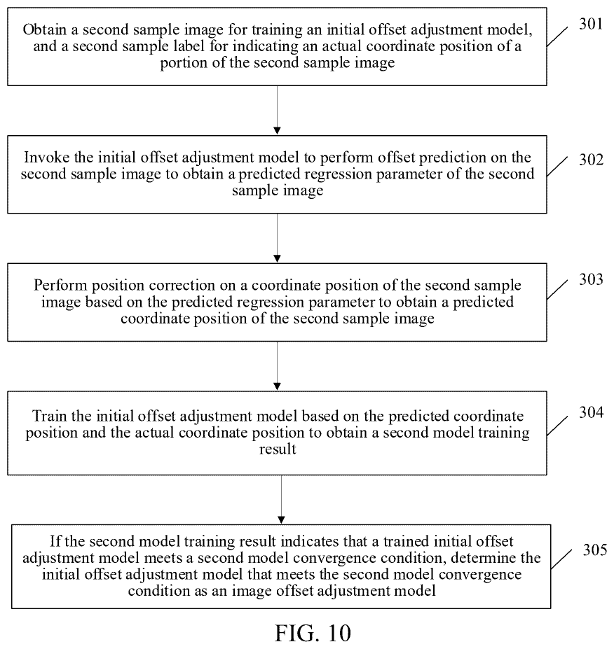

FIG. 10 is a schematic flowchart of a training method for an image offset adjustment model according to some embodiments. The method may be performed by a computer device with a model training function. The computer device may be a terminal device (for example, any terminal device in the terminal device cluster shown in FIG. 1, for example, the terminal device 100a), or may be a server with a model training function (for example, the server 10F shown in FIG. 1). This is not limited herein. The method may include at least the following operation 301 to operation 305:

Operation 301: Obtain a second sample image for training an initial offset adjustment model, and a second sample label for indicating an actual coordinate position of a portion of the second sample image.

To obtain a sufficient offset mode classification capability and minimize calculation complexity, in some embodiments, a network structure (for example, an A-Net) of the initial offset adjustment model may be constructed based on a network structure (for example, a D-Net) of an image detection model. For the initial offset adjustment model, refer to the network structure in FIG. 6. The initial offset adjustment model may include four convolutional layers, three pooling layers, one fully connected layer, and a final output layer (label layer).

If the portion belongs to a human face, because there are many public labeled face datasets for face detection on the Internet, an application may be directly submitted to an author to download a dataset. Training data further may be extracted from a labeled face dataset. A correct position of a face should be obtained from the labeled face dataset based on a face label, and a position offset (for example, an actual offset) is performed on the face to form an offset face and a corresponding offset parameter. In some embodiments, face images obtained through offsetting may be distinguished as a training set, a verification set, and a test set, and the training set may be used as the second sample image for performing a next training operation. The second sample label of the second sample image is configured for indicating an actual coordinate position of the second sample image, a coordinate position determined based on the offset parameter and a coordinate position of a face that exists before the offsetting.

Operation 302: Invoke the initial offset adjustment model to perform offset prediction on the second sample image to obtain a predicted regression parameter of the second sample image.

Operation 303: Adjust a coordinate position of the second sample image based on the predicted regression parameter to obtain a predicted coordinate position of the second sample image.

The computer device may separately adjust corresponding coordinates (for example, coordinates of a vertex, a width, or a height) of the coordinate position of the second sample image based on the formula (5) and each predicted offset in the predicted regression parameter of the second sample image, to determine the predicted coordinate position of the second sample image.

Operation 304: Train the initial offset adjustment model based on the predicted coordinate position and the actual coordinate position to obtain a second model training result.

The computer device may determine a model loss of the initial offset adjustment model based on the predicted coordinate position and the actual coordinate position indicated by the second sample label, and then may train the initial offset adjustment model based on the model loss of the initial offset adjustment model to obtain the second model training result.

For a region in which the portion of the second sample image is located, the initial offset adjustment model may predict an offset between the region and a nearest bounding box (for example, a predicted offset corresponding to an upper-left corner of the bounding box, a predicted offset corresponding to a height, and a predicted offset corresponding to a width). A learning objective is formulated as a regression issue. The model loss of the initial offset adjustment model may be determined based on a sample loss of each sample in the second sample image. A sample loss of a sample may be determined by using a Euclidean loss. Refer to the following formula (10):

$${L}_{i}^{box} = {‖ {y}_{i}^{′ box} - {y}_{i}^{box} ‖}_{2}^{2} \qquad ( 10 )$$

i is configured for representing an i^{th} sample in the second sample image. y′ᵢ^{box} is configured for representing a predicted coordinate position of the i^{th} sample that is determined based on the initial offset adjustment model. yᵢ^{box} is configured for representing a predicted coordinate position of the i^{th} sample that is determined based on the second sample label. The coordinate position herein includes four coordinates, which may include coordinates of an upper-left corner, a height, and a width. y′ᵢ^{box} ∈R⁴.

Operation 305: If the second model training result indicates that a trained initial offset adjustment model meets a second model convergence condition, determine the initial offset adjustment model that meets the second model convergence condition as an image offset adjustment model.

The second model convergence condition herein is that a current model loss reaches or exceeds a specified threshold or a quantity of training steps reaches or exceeds a specified threshold. A network structure (for example, an A-Net) of the image offset adjustment model may be a position correction network for a portion region. The network is configured to perform feature extraction on a to-be-detected image, and then correct a bounding box in which a portion is located by using a regression parameter of the bounding box.

In some embodiments, offset prediction is performed, by using a trained offset prediction depth model (for example, the image offset adjustment model 82W shown in FIG. 8), on the deduplicated candidate box set obtained in the foregoing process (for example, operation 102 in some embodiments corresponding to FIG. 3), and cyclic iterative position correction is performed to achieve more accurate localization. An adjusted box obtained in this solution has very high localization accuracy. A very small portion can be accurately localized, and adjacent or partially overlapping portions can be effectively distinguished.

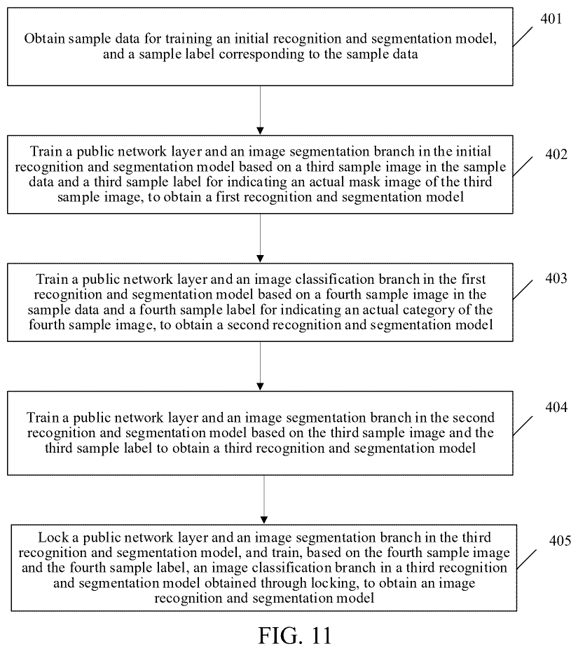

FIG. 11 is a schematic flowchart of a training method for an image recognition and segmentation model according to some embodiments. The method may be performed by a computer device with a model training function. The computer device may be a terminal device (for example, any terminal device in the terminal device cluster shown in FIG. 1, for example, the terminal device 100a), or may be a server with a model training function (for example, the server 10F shown in FIG. 1). This is not limited herein. The method may include at least the following operation 401 to operation 405:

Operation 401: Obtain sample data for training an initial recognition and segmentation model, and a sample label corresponding to the sample data.

To better describe image information of a portion macroscopically and microscopically, a residual module and a pyramid pooling module may be introduced into the initial recognition and segmentation model in some embodiments, to construct a network structure (for example, an S-Net) of the initial recognition and segmentation model. For details, refer to the network structure shown in FIG. 7. The initial recognition and segmentation model may include a public network layer 70G, an image classification branch 71f, and an image segmentation branch 72f.

Tasks of the network include an image classification task and an image segmentation task. Training sets for the two tasks may be incompatible. A reason is as follows: For the image segmentation task, if a sample image of a non-salient portion is introduced, a segmentation mask of the sample image of the non-salient portion is set as a full-image non-salient portion. A loss function in a training process increases by a plurality of times. This largely affects correct segmentation of a portion. In view of the foregoing factors, in some embodiments, staged training is performed for the two tasks. The sample data herein may include a third sample image for training an image segmentation branch and a fourth sample image for training an image classification branch, and the sample label herein may include a third sample label (configured for indicating an actual mask image) corresponding to the third sample image and a fourth sample label (configured for indicating an actual category) corresponding to the fourth sample image.

Because the network includes a label compatibility issue between the two tasks, multi-stage training may be performed in some embodiments. Loss functions are respectively defined for the two tasks in some embodiments. For a loss function of the image segmentation task, refer to the following formula (11):

$${L}^{seg} = - \frac{1}{N} {\sum }_{i = 1}^{N} {\sum }_{h}^{H} {\sum }_{w}^{W} {\sum }_{j}^{T} {y}_{ijwh} log ( \frac{{e}^{{f}_{ijwh}}}{{\sum }_{k = 1}^{K} {e}^{{f}_{ikwh}}} ) \qquad ( 11 )$$

N may represent a quantity of training samples in an iteration of the third sample image. His a height of a mask image. W is a width of the mask image. T is a quantity (for example, 2) of categories. f_{ijwh} may be configured for representing a predicted category confidence (for example, a second confidence) of an i^{th} sample for a j^{th} category at a pixel position (w, h). Y_{ijwh} may be configured for representing an actual category confidence (for example, a first confidence) of the i^{th} sample for the j^{th} category at the pixel position (w, h).

For a loss function of the image classification task, refer to the following formula (12):

$${L}^{classfy} = - \frac{1}{N} {\sum }_{i = 1}^{N} {\sum }_{j}^{T} {y}_{ij} log ( \frac{{e}^{{f}_{ij}}}{{\sum }_{k = 1}^{K} {e}^{{f}_{ik}}} ) \qquad ( 12 )$$

N may represent a quantity of training samples in an iteration of the fourth sample image. T is a quantity (for example, 2) of categories. fᵢⱼ may be configured for representing a predicted category confidence (for example, a sample prediction confidence) of an i^{th} sample for a j^{th} category. yᵢⱼ may be configured for representing an actual category confidence of the i^{th} sample for the j^{th} category.

Operation 402: Train the public network layer and the image segmentation branch in the initial recognition and segmentation model based on the third sample image in the sample data and the third sample label for indicating the actual mask image of the third sample image, to obtain a first recognition and segmentation model.

Operation 403: Train a public network layer and an image classification branch in the first recognition and segmentation model based on the fourth sample image in the sample data and the fourth sample label for indicating the actual category of the fourth sample image, to obtain a second recognition and segmentation model.

Operation 404: Train a public network layer and an image segmentation branch in the second recognition and segmentation model based on the third sample image and the third sample label to obtain a third recognition and segmentation model.

After performing operation 403, the computer device may repeatedly train the public network layer and the image segmentation branch in the second recognition and segmentation model based on the third sample image and the third sample label at a lower learning rate, until a loss is stable.

For example, the computer device may invoke the image segmentation branch in the second recognition and segmentation model to eliminate a non-salient portion of the third sample image to obtain a predicted mask image corresponding to the third sample image, and then may traverse pixels of the third sample image, and determine a pixel found through traversal as a to-be-processed pixel. The computer device may determine a confidence of the to-be-processed pixel in the actual mask image indicated by the third sample label as a first confidence, and determine a confidence of the to-be-processed pixel in the predicted mask image as a second confidence, and then may perform loss calculation on the first confidence and the second confidence based on the formula (11) to determine a model loss of the second recognition and segmentation model. Then the computer device may train the public network layer and the image segmentation branch in the second recognition and segmentation model based on the model loss of the second recognition and segmentation model to obtain a third model training result, and if the third model training result indicates that a trained second recognition and segmentation model meets a first branch convergence condition in a third model convergence condition, determine the second recognition and segmentation model that meets the first branch convergence condition as the third recognition and segmentation model. The first branch convergence condition herein may be that the model loss is stable.

Operation 405: Lock a public network layer and an image segmentation branch in the third recognition and segmentation model, and train, based on the fourth sample image and the fourth sample label, an image classification branch in a third recognition and segmentation model obtained through locking, to obtain an image recognition and segmentation model.

The computer device may lock the public network layer and the image segmentation branch in the third recognition and segmentation model, and then may determine the third recognition and segmentation model obtained through locking as a fourth recognition and segmentation model. The computer device may invoke the fourth recognition and segmentation model to perform recognition on the fourth sample image by using an image classification branch in the fourth recognition and segmentation model, to determine a sample prediction confidence corresponding to the fourth sample image, and then may perform, based on the formula (12), loss calculation on the actual category indicated by the fourth sample label and the sample prediction confidence, to determine a model loss of the fourth recognition and segmentation model. The computer device may train the image classification branch in the fourth recognition and segmentation model based on the model loss of the fourth recognition and segmentation model to obtain a fourth model training result, and if the fourth model training result indicates that a trained fourth recognition and segmentation model meets a second branch convergence condition in the third model convergence condition, determine the fourth recognition and segmentation model that meets the second branch convergence condition as the image recognition and segmentation model. The second branch convergence condition herein may also be that the model loss is stable. The trained image recognition and segmentation model in some embodiments is configured to perform operation 103 in some embodiments corresponding to FIG. 3. Recognition and segmentation are separately performed on each of the N cropped images by using the image recognition and segmentation model, to obtain a segmentation result associated with the portion.

In some embodiments, in the staged training method, a public network layer in the finally obtained image recognition and segmentation model (for example, the image recognition and segmentation model 83W shown in FIG. 8) can effectively express features of an input image for both of the two tasks, and respective tasks can be well performed after the features are transmitted to respective branches. In some embodiments, the two tasks are combined into one network, and are jointly trained in a plurality of stages during training, so that the network can learn of portion features incorporating both of the two tasks. An internal relationship between the two tasks can also enable the network to learn of a feature with better expressiveness during training, to achieve mutual gains. In terms of a structure of the image recognition and segmentation model, in some embodiments, a good balance is achieved between segmentation effect and an operation speed through structural optimization. Overall complexity of the network is not high, and operation efficiency of a single network may reach 25 frames per second. During actual application of the model, a background or another non-primary portion of a cropped image may be cleared based on image information of the cropped image by using the image segmentation branch in the image recognition and segmentation model, so that a portion of a segmented image is clearer and purer, and pixel-level image information (for example, human face information) can be output. Image detection may be performed again by using the image classification branch in the image recognition and segmentation model to predict a category of an adjusted box corresponding to the cropped image, to improve accuracy of image detection.

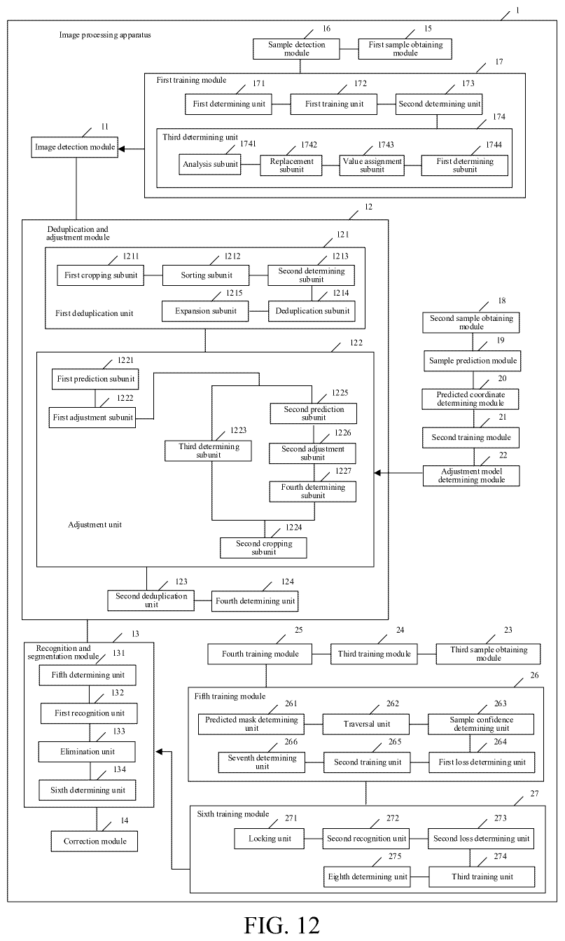

FIG. 12 is a schematic structural diagram of an image processing apparatus according to some embodiments. As shown in FIG. 12, the image processing apparatus 1 may include an image detection module 11, a deduplication and adjustment module 12, a recognition and segmentation module 13, a correction module 14, a first sample obtaining module 15, a sample detection module 16, a first training module 17, a second sample obtaining module 18, a sample prediction module 19, a predicted coordinate determining module 20, a second training module 21, an adjustment model determining module 22, a third sample obtaining module 23, a third training module 24, a fourth training module 25, a fifth training module 26, and a sixth training module 27.

The image detection module 11 is configured to perform, when a to-be-detected image is obtained, image detection on a portion of the to-be-detected image to obtain a candidate box set, the candidate box set including a candidate box for marking an image detection result.

The deduplication and adjustment module 12 is configured to deduplicate a candidate box in the candidate box set based on the to-be-detected image to obtain a to-be-processed box set, perform position correction on a candidate box in the to-be-processed box set to obtain an adjusted box, and generate, based on the adjusted box, an adjusted box set and a cropped image set corresponding to the adjusted box set, the cropped image set including N cropped images, a cropped image being obtained by cropping the to-be-detected image based on an adjusted box in the adjusted box set, and N being a positive integer.

The deduplication and adjustment module 12 includes a first deduplication unit 121, an adjustment unit 122, a second deduplication unit 123, and a fourth determining unit 124.

The first deduplication unit 121 is configured to deduplicate the candidate box in the candidate box set according to a deduplication rule based on shape-adaptive NMS to obtain the to-be-processed box set, the to-be-processed box set including a candidate box Xᵢ, i being a positive integer less than or equal to H, and H being configured for indicating a total quantity of candidate boxes in the to-be-processed box set.

The candidate box set is obtained by invoking an image detection model to perform image detection on the portion of the to-be-detected image. The candidate box set includes K candidate boxes, K being a positive integer. The image detection model is further configured to determine a predicted category confidence respectively corresponding to each of the K candidate boxes.

The first deduplication unit 121 includes a first cropping subunit 1211, a sorting subunit 1212, a second determining subunit 1213, a deduplication subunit 1214, and an expansion subunit 1215.

The first cropping subunit 1211 is configured to separately crop each of the K candidate boxes based on an image cropping rate specified according to the deduplication rule based on shape-adaptive NMS to obtain K cropped boxes.

The sorting subunit 1212 is configured to sort the K cropped boxes based on K predicted category confidences to obtain a sorting result.

The second determining subunit 1213 is configured to determine a cropped box with a highest predicted category confidence in the sorting result as a first cropped box, and determine (K-1) cropped boxes other than the first cropped box in the sorting result as a to-be-filtered set.

The deduplication subunit 1214 is configured to deduplicate the K cropped boxes based on an overlapping degree between the first cropped box and each cropped box in the to-be-filtered set to obtain a retained box set.

The deduplication subunit 1214 is further configured to:
retain the first cropped box, and separately determine the overlapping degree between the first cropped box and each cropped box in the to-be-filtered set;
if the to-be-filtered set includes an overlapping cropped box with an overlapping degree greater than an overlapping degree threshold, filter out the overlapping cropped box from the to-be-filtered set;
use a cropped box with a highest predicted category confidence in a to-be-filtered set obtained through filtering as a second cropped box, and use a cropped box in the to-be-filtered set obtained through filtering other than the second cropped box as a new to-be-filtered set; and
retain the second cropped box, and continue to deduplicate the new to-be-filtered set based on an overlapping degree between the second cropped box and each cropped box in the new to-be-filtered set until a to-be-filtered set obtained through deduplication is empty, and determine a retained cropped box as the retained box set, the retained box set including the first cropped box and the second cropped box.

The expansion subunit 1215 is configured to separately perform image expansion on each cropped box in the retained box set based on the image cropping rate to obtain the to-be-processed box set.

For some embodiments of the first cropping subunit 1211, the sorting subunit 1212, the second determining subunit 1213, the deduplication subunit 1214, and the expansion subunit 1215, refer to the descriptions of deduplicating the candidate box set in some embodiments corresponding to FIG. 5.

The adjustment unit 122 is configured to invoke an image offset adjustment model to perform position correction on the candidate box Xᵢ by using the to-be-detected image to obtain an adjusted box Yᵢ and a cropped image corresponding to the adjusted box Yᵢ.

The adjustment unit 122 includes a first prediction subunit 1221, a first adjustment subunit 1222, a third determining subunit 1223, a second cropping subunit 1224, a second prediction subunit 1225, a second adjustment subunit 1226, and a fourth determining subunit 1227.

The first prediction subunit 1221 is configured to invoke the image offset adjustment model to perform offset prediction on the candidate box Xᵢ by using the to-be-detected image to obtain a first regression parameter.

The first adjustment subunit 1222 is configured to perform position correction on the candidate box Xᵢ based on the first regression parameter to obtain a first adjusted box corresponding to the candidate box Xᵢ.

The third determining subunit 1223 is configured to: if the first regression parameter belongs to a regression parameter threshold range, determine the first adjusted box corresponding to the candidate box Xᵢ as the adjusted box Yᵢ corresponding to the candidate box Xᵢ.

The second cropping subunit 1224 is configured to crop the to-be-detected image based on a coordinate position of the adjusted box Yᵢ to obtain the cropped image corresponding to the adjusted box Yᵢ.

The second prediction subunit 1225 is configured to: if the first regression parameter does not belong to the regression parameter threshold range, invoke the image offset adjustment model to perform, by using the to-be-detected image, offset prediction on the first adjusted box corresponding to the candidate box Xᵢ to obtain a second regression parameter.

The second adjustment subunit 1226 is configured to perform, based on the second regression parameter, position correction on the first adjusted box corresponding to the candidate box Xᵢ to obtain a second adjusted box corresponding to the candidate box Xᵢ.

The fourth determining subunit 1227 is configured to: if the second regression parameter belongs to the regression parameter threshold range, determine the second adjusted box corresponding to the candidate box Xᵢ as the adjusted box Yᵢ corresponding to the candidate box Xᵢ.

For some embodiments of the first prediction subunit 1221, the first adjustment subunit 1222, the third determining subunit 1223, the second cropping subunit 1224, the second prediction subunit 1225, the second adjustment subunit 1226, and the fourth determining subunit 1227, refer to the descriptions of performing offset adjustment on the candidate box in some embodiments corresponding to FIG. 3.

The second deduplication unit 123 is configured to: when H adjusted boxes are obtained, deduplicate the H adjusted boxes according to the deduplication rule.

The fourth determining unit 124 is configured to determine an adjusted box obtained through deduplication as the adjusted box set corresponding to the candidate box set, and determine a cropped image corresponding to the adjusted box obtained through deduplication as the cropped image set corresponding to the adjusted box set.

For some embodiments of the first deduplication unit 121, the adjustment unit 122, the second deduplication unit 123, and the fourth determining unit 124, refer to the descriptions of operation 102 in some embodiments corresponding to FIG. 3.

The recognition and segmentation module 13 is configured to separately perform recognition and segmentation on each of the N cropped images to obtain a segmentation result associated with the portion, the segmentation result including M segmented images, and M being a positive integer less than or equal to N.

The recognition and segmentation module 13 includes a fifth determining unit 131, a first recognition unit 132, an elimination unit 133, and a sixth determining unit 134.

The fifth determining unit 131 is configured to determine a to-be-processed image from the N cropped images.

The first recognition unit 132 is configured to invoke an image recognition and segmentation model to perform recognition on the to-be-processed image by using an image classification branch in the image recognition and segmentation model to obtain a predicted category confidence corresponding to the to-be-processed image.

The elimination unit 133 is configured to eliminate a non-salient portion of the to-be-processed image by using an image segmentation branch in the image recognition and segmentation model to obtain a segmented image corresponding to the to-be-processed image.

The sixth determining unit 134 is configured to: if the predicted category confidence corresponding to the to-be-processed image is greater than a confidence threshold, determine the segmented image corresponding to the to-be-processed image as the segmentation result associated with the portion.

For some embodiments of the fifth determining unit 131, the first recognition unit 132, the elimination unit 133, and the sixth determining unit 134, refer to the descriptions of operation 103 in some embodiments corresponding to FIG. 3.

The correction module 14 is configured to separately correct adjusted boxes in the adjusted box set that correspond to the M segmented images, to obtain M corrected boxes for indicating the portion of the to-be-detected image.

The first sample obtaining module 15 is configured to obtain a first sample image for training a first detection model, and a first sample label for indicating an actual category of the first sample image, the first sample image being obtained by preprocessing a portion of a raw sample image.

The sample detection module 16 is configured to invoke the first detection model to perform image detection on the first sample image to obtain a predicted category confidence of the first sample image for the portion.

The first training module 17 is configured to train the first detection model based on the predicted category confidence of the first sample image and the actual category of the first sample image to obtain an image detection model for performing image detection on the portion of the to-be-detected image.

The first training module 17 includes a first determining unit 171, a first training unit 172, a second determining unit 173, and a third determining unit 174.

The first determining unit 171 is configured to perform loss calculation on the predicted category confidence of the first sample image and the actual category of the first sample image to determine a model loss of the first detection model.

The first training unit 172 is configured to train the first detection model based on the model loss of the first detection model to obtain a first model training result.

The second determining unit 173 is configured to: if the first model training result indicates that a trained first detection model meets a first model convergence condition, use the first detection model that meets the first model convergence condition as a second detection model.

The third determining unit 174 is configured to perform structural analysis on a network structure of the second detection model to obtain an analysis result, and generate, based on the analysis result and the second detection model, the image detection model for performing image detection on the portion of the to-be-detected image.

The third determining unit 174 includes an analysis subunit 1741, a replacement subunit 1742, a value assignment subunit 1743, and a first determining subunit 1744.

The analysis subunit 1741 is configured to perform structural analysis on a network structure of the second detection model to obtain an analysis result.

The replacement subunit 1742 is configured to: if the network structure of the second detection model includes a fully connected layer, replace the fully connected layer with a first convolutional layer configured with a sliding step.

The value assignment subunit 1743 is configured to assign a value to the first convolutional layer based on a network parameter of the fully connected layer to obtain a second convolutional layer.

The first determining subunit 1744 is configured to determine a second detection model including the second convolutional layer as the image detection model for performing image detection on the portion of the to-be-detected image.

For some embodiments of the analysis subunit 1741, the replacement subunit 1742, the value assignment subunit 1743, and the first determining subunit 1744, refer to the descriptions of performing network conversion on the second detection model in some embodiments corresponding to FIG. 9.

For some embodiments of the first determining unit 171, the first training unit 172, the second determining unit 173, and the third determining unit 174, refer to the descriptions of operation 203 in some embodiments corresponding to FIG. 9.

The second sample obtaining module 18 is configured to obtain a second sample image for training an initial offset adjustment model, and a second sample label for indicating an actual coordinate position of a portion of the second sample image.

The sample prediction module 19 is configured to invoke the initial offset adjustment model to perform offset prediction on the second sample image to obtain a predicted regression parameter of the second sample image.

The predicted coordinate determining module 20 is configured to perform position correction on a coordinate position of the second sample image based on the predicted regression parameter to obtain a predicted coordinate position of the second sample image.

The second training module 21 is configured to train the initial offset adjustment model based on the predicted coordinate position and the actual coordinate position to obtain a second model training result.

The adjustment model determining module 22 is configured to: if the second model training result indicates that a trained initial offset adjustment model meets a second model convergence condition, determine the initial offset adjustment model that meets the second model convergence condition as the image offset adjustment model.

The third sample obtaining module 23 is configured to obtain sample data for training an initial recognition and segmentation model, and a sample label corresponding to the sample data.

The third training module 24 is configured to train a public network layer and an image segmentation branch in the initial recognition and segmentation model based on a third sample image in the sample data and a third sample label for indicating an actual mask image of the third sample image, to obtain a first recognition and segmentation model.

The fourth training module 25 is configured to train a public network layer and an image classification branch in the first recognition and segmentation model based on a fourth sample image in the sample data and a fourth sample label for indicating an actual category of the fourth sample image, to obtain a second recognition and segmentation model.

The fifth training module 26 is configured to train a public network layer and an image segmentation branch in the second recognition and segmentation model based on the third sample image and the third sample label to obtain a third recognition and segmentation model.

The fifth training module 26 includes a predicted mask determining unit 261, a traversal unit 262, a sample confidence determining unit 263, a first loss determining unit 264, a second training unit 265, and a seventh determining unit 266.

The predicted mask determining unit 261 is configured to invoke the second recognition and segmentation model to eliminate a non-salient portion of the third sample image to obtain a predicted mask image corresponding to the third sample image.

The traversal unit 262 is configured to traverse pixels of the third sample image, and determine a pixel found through traversal as a to-be-processed pixel.

The sample confidence determining unit 263 is configured to determine a confidence of the to-be-processed pixel in the actual mask image indicated by the third sample label as a first confidence, and determine a confidence of the to-be-processed pixel in the predicted mask image as a second confidence.

The first loss determining unit 264 is configured to perform loss calculation on the first confidence and the second confidence to determine a model loss of the second recognition and segmentation model.

The second training unit 265 is configured to train the public network layer and the image segmentation branch in the second recognition and segmentation model based on the model loss of the second recognition and segmentation model to obtain a third model training result.

The seventh determining unit 266 is configured to: if the third model training result indicates that a trained second recognition and segmentation model meets a first branch convergence condition in a third model convergence condition, determine the second recognition and segmentation model that meets the first branch convergence condition as the third recognition and segmentation model.

For some embodiments of the predicted mask determining unit 261, the traversal unit 262, the sample confidence determining unit 263, the first loss determining unit 264, the second training unit 265, and the seventh determining unit 266, refer to the descriptions of operation 404 in some embodiments corresponding to FIG. 10.

The sixth training module 27 is configured to lock a public network layer and an image segmentation branch in the third recognition and segmentation model, and train, based on the fourth sample image and the fourth sample label, an image classification branch in a third recognition and segmentation model obtained through locking, to obtain the image recognition and segmentation model.

The sixth training module 27 includes a locking unit 271, a second recognition unit 272, a second loss determining unit 273, a third training unit 274, and an eighth determining unit 275.

The locking unit 271 is configured to lock the public network layer and the image segmentation branch in the third recognition and segmentation model, and determine the third recognition and segmentation model obtained through locking as a fourth recognition and segmentation model.

The second recognition unit 272 is configured to invoke the fourth recognition and segmentation model to perform recognition on the fourth sample image to determine a sample prediction confidence corresponding to the fourth sample image.

The second loss determining unit 273 is configured to perform loss calculation on the actual category indicated by the fourth sample label and the sample prediction confidence to determine a model loss of the fourth recognition and segmentation model.

The third training unit 274 is configured to train an image classification branch in the fourth recognition and segmentation model based on the model loss of the fourth recognition and segmentation model to obtain a fourth model training result.

The eighth determining unit 275 is configured to: if the fourth model training result indicates that a trained fourth recognition and segmentation model meets a second branch convergence condition in the third model convergence condition, determine the fourth recognition and segmentation model that meets the second branch convergence condition as the image recognition and segmentation model.

For some embodiments of the locking unit 271, the second recognition unit 272, the second loss determining unit 273, the third training unit 274, and the eighth determining unit 275, refer to the descriptions of operation 405 in some embodiments corresponding to FIG. 10.

For some embodiments of the image detection module 11, the deduplication and adjustment module 12, the recognition and segmentation module 13, the correction module 14, the first sample obtaining module 15, the sample detection module 16, the first training module 17, the second sample obtaining module 18, the sample prediction module 19, the predicted coordinate determining module 20, the second training module 21, the adjustment model determining module 22, the third sample obtaining module 23, the third training module 24, the fourth training module 25, the fifth training module 26, and the sixth training module 27, refer to the descriptions of the image processing method in some embodiments corresponding to FIG. 3, FIG. 9, FIG. 10, and FIG. 11.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

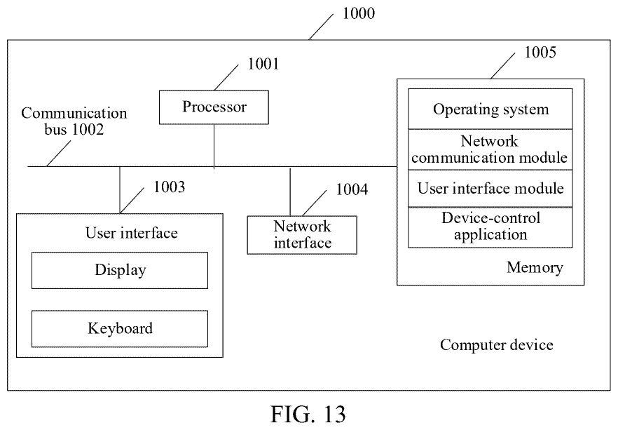

FIG. 13 is a schematic diagram of a computer device according to some embodiments. As shown in FIG. 13, the computer device 1000 may include at least one processor 1001, for example, a CPU, at least one network interface 1004, a memory 1005, and at least one communication bus 1002. The communication bus 1002 is configured to implement connection and communication between these components. In some embodiments, the network interface 1004 may include a standard wired interface and wireless interface (for example, a Wi-Fi interface). The memory 1005 may be a high-speed RAM memory, or may be a non-volatile memory, for example, at least one magnetic disk memory. In some embodiments, the memory 1005 may be at least one storage apparatus located away from the processor 1001. As shown in FIG. 13, the memory 1005 used as a computer storage medium may include an operating system, a network communication module, a user interface module, and a device-control application. In some embodiments, the computer device may further include a user interface 1003 shown in FIG. 13. For example, if the computer device is a terminal device with a model training function shown in FIG. 1 (for example, the terminal device 100a), the computer device may further include the user interface 1003. The user interface 1003 may include a display, a keyboard, and the like.

In the computer device 1000 shown in FIG. 13, the network interface 1004 is configured to perform network communication, the user interface 1003 is configured to provide an input interface for a user, and the processor 1001 may be configured to invoke the device-control application stored in the memory 1005 to implement the following operations:
performing, when a to-be-detected image is obtained, image detection on a portion of the to-be-detected image to obtain a candidate box set, the candidate box set including a candidate box for marking an image detection result;
deduplicating a candidate box in the candidate box set based on the to-be-detected image to obtain a to-be-processed box set, performing position correction on a candidate box in the to-be-processed box set to obtain an adjusted box, and generating, based on the adjusted box, an adjusted box set and a cropped image set corresponding to the adjusted box set, the cropped image set including N cropped images, a cropped image being obtained by cropping the to-be-detected image based on an adjusted box in the adjusted box set, and N being a positive integer;
separately performing recognition and segmentation on each of the N cropped images to obtain a segmentation result associated with the portion, the segmentation result including M segmented images, and M being a positive integer less than or equal to N; and
separately correcting, based on coordinate positions of the M segmented images, adjusted boxes in the adjusted box set that correspond to the M segmented images, to obtain M corrected boxes for indicating the portion of the to-be-detected image.

The computer device 1000 described in some embodiments may perform the descriptions of the image processing method in some embodiments corresponding to FIG. 3, FIG. 9, FIG. 10, and FIG. 11, or may perform the descriptions of the image processing apparatus 1 in some embodiments corresponding to FIG. 12. Beneficial effects of the same method are not described herein again.

Some embodiments further provide a computer-readable storage medium. The computer-readable storage medium has a computer program stored therein. The computer program includes program instructions. When the program instructions are executed by a processor, the image processing method provided in the operations in FIG. 3, FIG. 9, FIG. 10, and FIG. 11 is implemented. Refer to some embodiments provided in the operations in FIG. 3, FIG. 9, FIG. 10, and FIG. 11.

The computer-readable storage medium may be an internal storage unit of the data transmission apparatus or the computer device provided in any one of some embodiments, for example, a hard disk or an internal memory of the computer device. The computer-readable storage medium may be an external storage device of the computer device, for example, a plug-in hard disk, a smart media card (SMC), a secure digital (SD) card, or a flash card that is deployed in the computer device. The computer-readable storage medium may include both an internal storage unit and an external storage device of the computer device. The computer-readable storage medium is configured to store the computer program and other programs and data that are used by the computer device. The computer-readable storage medium may be further configured to temporarily store data that has been output or is to be output.

Some embodiments further provide a computer program product, including a computer program. The computer program is stored in a computer-readable storage medium. A processor of a computer device reads the computer program from the computer-readable storage medium. The processor executes the computer program, to enable the computer device to perform the descriptions of the image processing method or apparatus in some embodiments.

Claims, and accompanying drawings of embodiments of this application, the terms “first”, “second”, and the like are intended to distinguish between different objects but do not indicate a particular order. The terms “include” and any variant thereof are intended to cover a non-exclusive inclusion. For example, a process, a method, an apparatus, a product, or a device that includes a series of operations or units is not limited to the listed operations or modules, and in some embodiments, further includes other unlisted operations or modules, or further includes other inherent operations or units of the process, the method, the apparatus, the product, or the device.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, comprising:
performing, based on an image being obtained, image detection on a first portion of the image to obtain a first box set comprising at least one box for marking an image detection result;
deduplicating a first box in the first box set based on the image to obtain a second box set;
performing position correction on a second box in the second box set to obtain a third box that is adjusted;
generating, based on the third box, a third box set of adjusted boxes and a cropped image set corresponding to the third box set, the cropped image set comprising one or more first cropped images that are obtained by cropping the image based on one or more first adjusted boxes in the third box set;
performing recognition and segmentation on the one or more first cropped images to obtain a segmentation result associated with the first portion, the segmentation result comprising one or more segmented images, a first number of the one or more segmented images being less than or equal to a second number of the one or more first adjusted boxes; and
correcting the one or more first adjusted boxes, based on one or more coordinate positions of the one or more segmented images, to generate one or more corrected boxes for the first portion.

2. The image processing method according to claim 1, wherein before the image detection is performed, the image processing method further comprises:
obtaining a first sample image for training a first detection model, and a first sample label indicating a category of the first sample image, the first sample image being obtained by preprocessing a second portion of a raw sample image;
invoking the first detection model to perform image detection on the first sample image to obtain a predicted category confidence of a third portion of the first sample image corresponding to the second portion; and
training the first detection model based on the predicted category confidence of the first sample image and the category of the first sample image to obtain an image detection model for performing the image detection on the first portion, and
wherein the performing the image detection on the first portion comprises:
performing, based on the image being obtained, the image detection on the first portion by using the image detection model to obtain the first box set.

3. The image processing method according to claim 2, wherein the training the first detection model comprises:
calculating a loss based on the predicted category confidence of the first sample image and the category of the first sample image to determine a model loss of the first detection model;
training the first detection model based on the model loss of the first detection model to obtain a first model training result;
based on the first model training result indicating that the first detection model satisfies a first model convergence condition, using the first detection model as a second detection model; and
performing structural analysis on a network structure of the second detection model to obtain an analysis result, and generating the image detection model, based on the analysis result and the second detection model.

4. The image processing method according to claim 3, wherein the generating the image detection model comprises:
the performing the structural analysis on the network structure of the second detection model to obtain the analysis result;
based on the analysis result indicating that the network structure of the second detection model comprises a fully connected layer, replacing the fully connected layer with a first convolutional layer comprising a sliding step;
assigning a value to the first convolutional layer based on a network parameter of the fully connected layer to obtain a second convolutional layer; and
determining a third detection model comprising the second convolutional layer as the image detection model.

5. The image processing method according to claim 2, wherein the generating the third box set and the cropped image set comprises:
deduplicating the first box set based on a deduplication rule comprising shape-adaptive non-maximum suppression (NMS) to obtain the second box set, wherein the second box set comprises one or more candidate boxes;
invoking an image offset adjustment model to perform the position correction on the one or more candidate boxes by using the image to obtain one or more second adjusted boxes and one or more second cropped images corresponding to the one or more second adjusted boxes;
based on a third number of the one or more second adjusted boxes being obtained that corresponds to a fourth number of the one or more candidate boxes, deduplicating the one or more second adjusted boxes based on the deduplication rule; and
determining the third box set based on the one or more second adjusted boxes being deduplicated, and determining the cropped image set based on the one or more second cropped images.

6. The image processing method according to claim 5, wherein the first box set is obtained by invoking the image detection model to perform image detection on the first portion, the first box set comprises K candidate boxes, wherein K is a positive integer, and the image detection model is further configured to determine one or more predicted category confidences corresponding to the K candidate boxes, and
wherein the deduplicating the first box according to the deduplication rule comprises:
cropping the K candidate boxes based on an image cropping rate determined based on the deduplication rule to obtain K cropped boxes;
sorting the K cropped boxes based on K predicted category confidences to obtain a sorting result;
determining a first cropped box with a highest predicted category confidence in the sorting result, and determining (K-1) cropped boxes other than the first cropped box in the sorting result as a fourth box set;
deduplicating the K cropped boxes based on overlapping degrees between the first cropped box and the fourth box set to obtain a fifth box set; and
performing image expansion on the fifth box set based on the image cropping rate to obtain the second box set.

7. The image processing method according to claim 6, wherein the deduplicating the K cropped boxes comprises:
retaining the first cropped box, and determining overlapping degrees between the first cropped box and the (K-1) cropped boxes;
based on the fourth box set comprising an overlapping cropped box with overlapping degrees greater than an overlapping degree threshold, filtering out the overlapping cropped box from the fourth box set;
obtaining a second cropped box with a highest predicted category confidence in a sixth box set through filtering, and using one or more cropped boxes in the sixth box set as a seventh box set; and
retaining the second cropped box, and continuing to deduplicate the seventh box set based on overlapping degrees between the second cropped box and the one or more cropped boxes until an eighth box set obtained through deduplication is empty, and determining one or more retained cropped boxes as the fifth box set, wherein the fifth box set comprises the first cropped box and the second cropped box.

8. The image processing method according to claim 5, wherein the invoking the image offset adjustment model comprises:
invoking the image offset adjustment model to perform offset prediction on the one or more candidate boxes by using the image to obtain a first regression parameter;
performing position correction on the one or more candidate boxes based on the first regression parameter to obtain one or more third adjusted boxes corresponding to the one or more candidate boxes;
based on the first regression parameter belonging to a regression parameter threshold range, determining the one or more third adjusted boxes as the one or more second adjusted boxes; and
cropping the image based on a first coordinate position of the one or more second adjusted boxes to obtain the cropped image set.

9. The image processing method according to claim 8, further comprising:
based on the first regression parameter not belonging to the regression parameter threshold range, invoking the image offset adjustment model to perform, by using the image, offset prediction on the one or more third adjusted boxes to obtain a second regression parameter;
performing, based on the second regression parameter, position correction on the one or more third adjusted boxes to obtain one or more fourth adjusted boxes corresponding to the one or more candidate boxes; and
based on the second regression parameter belonging to the regression parameter threshold range, determining the one or more fourth adjusted boxes as the one or more second adjusted boxes.

10. The image processing method according to claim 5, wherein before the invoking the image offset adjustment model, the image processing method further comprises:
obtaining a second sample image for training an initial offset adjustment model, and a second sample label for indicating a second coordinate position of a fourth portion of the second sample image;
invoking the initial offset adjustment model to perform offset prediction on the second sample image to obtain a predicted regression parameter of the second sample image;
performing position correction on a third coordinate position of the second sample image based on the predicted regression parameter to obtain a predicted coordinate position of the second sample image;
training the initial offset adjustment model based on the predicted coordinate position and the second coordinate position to obtain a second model training result; and
if the second model training result indicates that a trained initial offset adjustment model meets a second model convergence condition, determining the initial offset adjustment model that meets the second model convergence condition as the image offset adjustment model.

11. An image processing apparatus, comprising:
at least one memory configured to store computer program code; and
at least one processor configured to read the program code and operate as instructed by the program code, the program code comprising:
image detection code configured to cause at least one of the at least one processor to perform, based on an image being obtained, image detection on a first portion of the image to obtain a first box set comprising at least one box for marking an image detection result;
deduplication and adjustment code configured to cause at least one of the at least one processor to:
deduplicate a first box in the first box set based on the image to obtain a second box set;
perform position correction on a second box in the second box set to obtain a third box that is adjusted; and
generate, based on the third box, a third box set of adjusted boxes and a cropped image set corresponding to the third box set, the cropped image set comprising one or more first cropped images that are obtained by cropping the image based on one or more first adjusted boxes in the third box set;
recognition and segmentation code configured to cause at least one of the at least one processor to perform recognition and segmentation on the one or more first cropped images to obtain a segmentation result associated with the first portion, the segmentation result comprising one or more segmented images, a first number of the one or more segmented images being less than or equal to a second number of the one or more first adjusted boxes; and
correction code configured to cause at least one of the at least one processor to correct the one or more first adjusted boxes, based on one or more coordinate positions of the one or more segmented images, to generate one or more corrected boxes for the first portion.

12. The image processing apparatus according to claim 11, the program code further comprises obtaining code configured to cause at least one of the at least one processor to:
obtain a first sample image for training a first detection model, and a first sample label indicating a category of the first sample image, the first sample image being obtained by preprocessing a second portion of a raw sample image;
invoke the first detection model to perform image detection on the first sample image to obtain a predicted category confidence of a third portion of the first sample image corresponding to the second portion; and
train the first detection model based on the predicted category confidence of the first sample image and the category of the first sample image to obtain an image detection model for performing the image detection on the first portion, and
wherein the image detection code is configured to cause at least one of the at least one processor to perform, based on the image being obtained, the image detection on the first portion by using the image detection model to obtain the first box set.

13. The image processing apparatus according to claim 12, wherein the obtaining code is configured to cause at least one of the at least one processor to:
calculate a loss based on the predicted category confidence of the first sample image and the category of the first sample image to determine a model loss of the first detection model;
train the first detection model based on the model loss of the first detection model to obtain a first model training result;
based on the first model training result indicating that the first detection model satisfies a first model convergence condition, using the first detection model as a second detection model; and
perform structural analysis on a network structure of the second detection model to obtain an analysis result, and generating the image detection model, based on the analysis result and the second detection model.

14. The image processing apparatus according to claim 13, wherein the obtaining code is configured to cause at least one of the at least one processor to:
perform the structural analysis on the network structure of the second detection model to obtain the analysis result;
based on the analysis result indicating that the network structure of the second detection model comprises a fully connected layer, replace the fully connected layer with a first convolutional layer comprising a sliding step;
assign a value to the first convolutional layer based on a network parameter of the fully connected layer to obtain a second convolutional layer; and
determine a third detection model comprising the second convolutional layer as the image detection model.

15. The image processing apparatus according to claim 12, wherein the obtaining code is configured to cause at least one of the at least one processor to:
deduplicate the first box set based on a deduplication rule comprising shape-adaptive non-maximum suppression (NMS) to obtain the second box set, wherein the second box set comprises one or more candidate boxes;
invoke an image offset adjustment model to perform the position correction on the one or more candidate boxes by using the image to obtain one or more second adjusted boxes and one or more second cropped images corresponding to the one or more second adjusted boxes;
based on a third number of the one or more second adjusted boxes being obtained that corresponds to a fourth number of the one or more candidate boxes, deduplicate the one or more second adjusted boxes based on the deduplication rule; and
determine the third box set based on the one or more second adjusted boxes being deduplicated, and determine the cropped image set based on the one or more second cropped images.

16. The image processing apparatus according to claim 15, wherein the first box set is obtained by invoking the image detection model to perform image detection on the first portion, the first box set comprises K candidate boxes, wherein K is a positive integer, and the image detection model is further configured to determine one or more predicted category confidences corresponding to the K candidate boxes, and
wherein the obtaining code is configured to cause at least one of the at least one processor to:
crop the K candidate boxes based on an image cropping rate determined based on the deduplication rule to obtain K cropped boxes;
sort the K cropped boxes based on K predicted category confidences to obtain a sorting result;
determine a first cropped box with a highest predicted category confidence in the sorting result, and determining (K-1) cropped boxes other than the first cropped box in the sorting result as a fourth box set;
deduplicate the K cropped boxes based on overlapping degrees between the first cropped box and the fourth box set to obtain a fifth box set; and
perform image expansion on the fifth box set based on the image cropping rate to obtain the second box set.

17. The image processing apparatus according to claim 16, wherein the obtaining code is configured to cause at least one of the at least one processor to:
retain the first cropped box, and determining overlapping degrees between the first cropped box and the (K-1) cropped boxes;
based on the fourth box set comprising an overlapping cropped box with overlapping degrees greater than an overlapping degree threshold, filter out the overlapping cropped box from the fourth box set;
obtain a second cropped box with a highest predicted category confidence in a sixth box set through filtering, and use one or more cropped boxes in the sixth box set as a seventh box set; and
retain the second cropped box, and continue to deduplicate the seventh box set based on overlapping degrees between the second cropped box and the one or more cropped boxes until an eighth box set obtained through deduplication is empty, and determine one or more retained cropped boxes as the fifth box set, wherein the fifth box set comprises the first cropped box and the second cropped box.

18. The image processing apparatus according to claim 15, wherein the obtaining code is configured to cause at least one of the at least one processor to:
invoke the image offset adjustment model to perform offset prediction on the one or more candidate boxes by using the image to obtain a first regression parameter;
perform position correction on the one or more candidate boxes based on the first regression parameter to obtain one or more third adjusted boxes corresponding to the one or more candidate boxes;
based on the first regression parameter belonging to a regression parameter threshold range, determine the one or more third adjusted boxes as the one or more second adjusted boxes; and
crop the image based on a first coordinate position of the one or more second adjusted boxes to obtain the cropped image set.

19. The image processing apparatus according to claim 18, wherein the obtaining code is configured to cause at least one of the at least one processor to:
based on the first regression parameter not belonging to the regression parameter threshold range, invoke the image offset adjustment model to perform, by using the image, offset prediction on the one or more third adjusted boxes to obtain a second regression parameter;
perform, based on the second regression parameter, position correction on the one or more third adjusted boxes to obtain one or more fourth adjusted boxes corresponding to the one or more candidate boxes; and
based on the second regression parameter belonging to the regression parameter threshold range, determine the one or more fourth adjusted boxes as the one or more second adjusted boxes.

20. A non-transitory computer-readable storage medium, storing computer code which, when executed by at least one processor, causes the at least one processor to at least:
perform, based on an image being obtained, image detection on a first portion of the image to obtain a first box set comprising at least one box for marking an image detection result;
deduplicate a first box in the first box set based on the image to obtain a second box set;
perform position correction on a second box in the second box set to obtain a third box that is adjusted;
generate, based on the third box, a third box set of adjusted boxes and a cropped image set corresponding to the third box set, the cropped image set comprising one or more first cropped images that are obtained by cropping the image based on one or more first adjusted boxes in the third box set;
perform recognition and segmentation on the one or more first cropped images to obtain a segmentation result associated with the first portion, the segmentation result comprising one or more segmented images, a first number of the one or more segmented images being less than or equal to a second number of the one or more first adjusted boxes; and
correct the one or more first adjusted boxes, based on one or more coordinate positions of the one or more segmented images, to generate one or more corrected boxes for the first portion.
